(19) United States
(12) Patent Application Publication
(10) Pub. No.: US 2022/0297558 A1
(43) Pub. Date: Sep. 22, 2022

(54) Breaker Plugs, Systems and Methods

(71) Applicants: Daniel J Daoura, Renton, WA (US); Kal K Lambert, Hammond, OR (US)

(72) Inventors: Daniel J Daoura, Renton, WA (US); Kal K Lambert, Hammond, OR (US)

(21) Appl. No.: 17/837,015

(22) Filed: Jun. 9, 2022

Related U.S. Application Data
(63) Continuation-in-part of application No. 17/467,203, filed on Sep. 4, 2021.
Application No. 17/467,203 is a continuation-in-part of application No. 17/144,106, filed on Jan. 7, 2021, now Pat. No. 11,139,640.
(60) Provisional application No. 62/963,119, filed on Jan. 19, 2020.
(60) Provisional application No. 63/349,530, filed on Jun. 6, 2022.
(60) Provisional application No. 63/321,925, filed on Mar. 21, 2022.

(51) Int. Cl. B60L 53/30; B60L 53/16; B60L 53/66; H02J 7/00; H01H 71/02; H02H 3/16

(52) U.S. Cl. CPC B60L 53/30; B60L 53/16; B60L 53/66; H02J 7/0031; H01H 71/0264; H02H 3/16

(57) ABSTRACT

Breaker/plug combination device with “plug-in” receptacle that mounts in a breaker panel. The plug receptacle connects line feed to a power cord inserted by the operator. The devices include a multifunction circuit interrupt that offers overload, thermal, and ground fault (GFCI) protection for the operator in environments such as garages, shops and spider boxes at construction sites, for example, and for electric vehicle (EV) charging. Given the shortage of charging stations for EVs, the devices offer a convenient way to set up home charging without the need for an electrician, a sub-box, or a specially-installed wall plug outlet. The devices may include watchdog circuitry and networkable communications circuitry that is compatible with a wired or wireless TOT network. In another embodiment that does not require adding a new circuit breaker, a dummy breaker body includes a plug receptacle with a GFCI interrupt circuit but with no direct electrical connection to the hot bus bar, and is wired in series with a conventional circuit breaker unit. Using solid state electronics, the GFCI panel-mounted devices may be configured to perform an automatic fault test on a regular schedule or prior to each use, and to store and report fault status.

### CROSS REFERENCE TO RELATED APPLICATIONS

This application is a Continuation-in-Part of U.S. patent Ser. No. 17/467,203 entitled “Breaker Plug” Network Systems and Methods, filed 4 Sep. 2021; which is a Continuation-in-Part of U.S. patent Ser. No. 17/144,106 entitled “Breaker Plug”, filed 7 Jan. 2021, now U.S. patent Ser. No. 11/139,640, which is related to and claims priority under 37 USC 119(e) to US Provisional Patent Ser. No. 62/963,119 entitled “Breaker Plug,” filed 19 Jan. 2020. This application also claims priority to US Provisional Patent Ser. No. 63/349,530 filed 6 Jun. 2022 and US Provisional Patent Ser. No. 63/321,925 filed 29 Mar. 2022. All said patent documents are incorporated in full by reference for all purposes.

### TECHNICAL FIELD

This disclosure pertains generally to the field of electric power solutions for using breaker-plug combination devices to access AC electrical power from a load panel.

### BACKGROUND

A solution to the problem of tapping line power directly from a load panel (“breaker panel”) is addressed that overcomes the need to install a hardwired electrical outlet outside the load panel, while not creating an unsafe condition. The need for accessible 240 VAC plug-in power is acute given the increasing demand for home charging stations for battery-powered electric vehicles (BEV, EV). Also, because load panels are sometimes situated in temporary structures or in garages, for example, where wetness, construction and demolition, and ground leaks are likely, there may also be a need, indeed a requirement, for a ground fault interrupt at the level of the load panel, no longer just at the plug receptacle outlet. Of historical interest in evaluating this problem are U.S. Pat. No. 3,213,321 to Dalziel, U.S. Pat. No. 3,922,586 to Buxton, and U.S. Pat. No. 5,574,612 to Pak.

In another aspect, the problem relates to 240 VAC in which two hot leads, each having a feed that is 180 degrees out of phase, are applied across a load. The neutral wire may be dispensed with in some applications. Many currently available EV chargers, for example, are not provided with a neutral wire, and if the ground wire connects to neutral in a subpanel, a potentially dangerous situation is created in which multiple paths to ground may be taken by live current.

Also, use of bayonet plugs in removably pluggable devices in the receptacle creates a dangerous situation because the mechanical life of the receptacle sheathed connectors are limited and the prongs of a male plug will begin to loosen in the receptacle over 100 uses or fewer. The most commonly specified plug-in type electric vehicle charging units rely on NEMA 14-50R and 6-50R plugs (US National Electrical Manufacturers Association), both of which are prone to loosening of the electrical contacts with repeated use. This problem is also commonly encountered in homes and businesses where 120 and 240 VAC straight-prong “bayonet” plugs are used, leading to occasional burned fingers and possible arc shorts due to bending and handling of plug prongs that are loose in the plug receptacle.

Aviation type plugs have not generally been adopted for commercial use in the United States, and the twist-locking plugs of the NEMA L-series are seldom installed. The task of upgrading the plug receptacles in millions of homes and businesses, even in those applications where 240 VAC voltages are required, is not an easy or inexpensive one. Instead the approach has been to tighten electrical codes for new construction to include personal protective features such as plug receptacle covers, ground fault circuit interrupts (GFCI) and arc fault interrupts (AFI). This improved hardware is not available in existing homes and businesses, and to be installed country-wide would require a major effort, with no apparent readily available option.

In overcoming the dangers of AC power and maximizing its uses, these problems are of interest to homeowners, homebuilders, tradespersons, and hobbyists and are of general interest in industries where AC electrical power is used, particularly given the rapidly expanding adoption of EVs and lack of widely available home charging equipment.

### SUMMARY

As a first embodiment, disclosed is a “circuit breaker/plug” combination, which comprises, in a single unit, (a) a circuit breaker body with multifunction breaker, plus (b) a plug receptacle electrically connected in series to the breaker—and is designed to be mounted inside a “load panel” (also sometimes termed a breaker panel or service panel) that receives grid power and distributes it to branch circuits within a power customer's facility. The circuit breaker body is of a modular type, generally molded in construction, and having dimensions to be compatible with a slot or slots of a manufacturer's load panel. The individual breaker units generally are fitted with snap-on features, and are wired in parallel across the bus bars of the load panel. Each breaker may be specified according to its amperage limit, and may include optional features such as GFCI or dual GFCI/AFI protection.

As first embodied, the circuit breaker/plug combination body is configured to be connectedly mounted to a hot bus bar inside the load panel and the plug receptacle is configured to receive a detachable cord-mounted plug for conveying AC current to an appliance or tool (generically a “load”) in need of power. The breaker/plug unit may be affixed in the load panel on a ail or rails, may otherwise detachably mount to the power supply interface as per the standard for the country of use. The breaker body will conform to a modular standard so as to be interchangeable with other circuit breaker units in the load panel provided by the manufacturer.

Combination breaker/plug receptacle devices are configured to comply with standards and codes for use in domestic and industrial load panels. The modular devices may snap into place on hot shoes or on a hot rail of a bus bar and may be removed when not needed—or may be permanently installed without causing mechanical interference with the load panel door when not in use. Current codes do not require that the door of the load panel be closed when live—because a secondary “dead cover” is mounted over the wiring and only fully grounded user-accessible surfaces of the breakers are exposed when the door is open and the breaker controls are accessible.

In variants of the invention in its first embodiment, models compatible with 120 VAC, 240 VAC and 480 VAC, including both single phase and three phase, are provided with plug receptacles for receiving mating electrical cords. Receptacles for male bayonet plugs, twist-lock plugs, and aviation plugs are provided in a family of products. The circuit breakers are configured according to accepted ratings from 15 to 50 Amp or higher. Circuit overload and thermal breakers are generally standard. GFCI models are provided in which the GFCI circuit is connected to the breaker/plug receptacle for detecting ground leakage. Safety is not sacrificed when operating tools or appliances from a plug receptacle installed within a load panel, and may be enhanced by incorporating other personal protection features in the breaker/plug body.

Disclosed in a second embodiment is a family of devices having a modular dummy circuit breaker body which comprises a plug receptacle—but no working circuit breaker and no direct connection to the hot bus bar. The modular dummy breaker body seats on the hot bus bar in a load panel in the same way as a conventional circuit breaker, but does not receive power via a hot shoe in the base of the body, and is instead wired to a hot lead in series with an adjacent genuine circuit breaker. The plug receptacle is wires such that insertion of a plug into the receptacle completes the circuit. The plug receptacles are grounded and require a dedicated connection to a ground bus or lug.

Advantageously, in this embodiment, the circuit breaker body is a conventional assembly, but is wired in series with an innovative dummy breaker body with plug receptacle. The body dimensions are compatible with a standard slot width, height and length so as seat in the same load panel as the genuine circuit breaker units. A tool or appliance can be plugged into the dummy breaker unit and turned on, while still protected by the series circuit breaker from overload, arc short, or overheating, for example. The device wiring is installed with the breaker OFF, and powered by setting the breaker ON when installation is complete. In a useful innovation, the dummy breaker body may include the GFCI circuitry that is not typically found in most existing circuit breaker units. By providing the dummy breaker body with an internal GFCI circuit interrupt, the combination of circuit breaker plus plug receptacle in series has overload, thermal and ground fault interrupt breaker functions without increasing the electromechanical complexity or cost of the standard genuine circuit breaker unit.

In a first exemplary device combination, the two body units (genuine breaker and dummy breaker/plug) are wired separately and may sit side-by-side within the load panel. In a second exemplary device combination, the two body units, while wired separately, share a fused lateral wall and are inseparable. Each “single-wide” body (each modular unit width defining a standard width of a “slot”), when mounted side-by-side, seats as a “double-wide” pair of modular units in the load panel. For larger plug receptacles such as the NEMA 14-50R, the dummy breaker body can add two or three slot widths. This increased width permits increased use of solid-state circuitry, battery storage capacity, and a larger user interface on top of the device.

In more advanced embodiments, networking capacity is added so that the device(s) can be monitored remotely. The dummy breaker body can include a printed circuit board, for example, with radio unit. We have found that the heavy steel box frame and deadpanel of the load panel does not interfere with Bluetooth radio signals conveying information to a smartphone or external radio hub, for example. By adding a rechargeable battery and memory, event records can be stored locally and are available to a technician during servicing even after the mains switch is disconnected. BT radio also enables a communications link to a vehicle, and can facilitate configuration of the breaker and OBCM (on-board charging module) of the BEV.

By using solid state elements such as a silicon controlled rectifier (thyristor, SCR) with solenoid, FET, or solid state switch, the devices can include automated testing and reset during down time or at programmed intervals. Self-testing may be automated to improve the safety of the devices and may include reporting to a remote monitor so as to ensure compliance with the newer codes.

In another embodiment, the load panel may be provided with a function-added coverpanel, that seats on top of the front “dead” coverpanel. The coverpanel may be a selectively radiotransparent material, may be inductively powered at low amperage and voltage, and may include a radio antenna. Smart breakers in the panel may couple to the antenna by an inductive link using NFC or resonance modulation radio, or may receive and send data using spread spectrum radio technologies to minimize interference from the AC field. Alternatively the smart breaker devices may include a microstrip antenna that includes an earth ground plane coupled by a bayonet connection to the radioset of the smart breaker. Networking of these devices offers new levels of safety not available for home installations, for example.

The elements, features, steps, and advantages of one or more embodiments will be more readily understood upon consideration of the following detailed description, taken in conjunction with the accompanying drawings, in which embodiments, including details, conceptual elements, and current practices, are illustrated by way of example.

It is to be expressly understood, however, that the drawings are for illustration and description only and are not intended as a definition of the limits of the embodiments and conceptual basis as claimed. The various elements, features, steps, and combinations thereof that characterize aspects of the claimed matter are pointed out with particularity in the claims annexed to and forming part of this disclosure. The invention(s) do not necessarily reside in any one of these aspects taken alone, but rather in the invention(s) taken as a whole.

### BRIEF DESCRIPTION OF THE DRAWINGS

One or more embodiments are taught and are more readily understood by considering the drawings in association with the specification, in which:

FIG. 1A is view of a first load panel that includes a metal frame and dead cover for wall mounting and typically a hinged door (not shown).

FIG. 1B is an open view of the load panel with dead cover removed so as to expose a breaker/plug device, a plug receptacle, and connections to the bus bars.

FIG. 1C is a partial view of a load panel that isolates one exemplary breaker/plug device 100 with NEMA 6-50 plug receptacle mounted on the bus bars.

FIG. 1D illustrates a breaker/plug device for receiving a 3-pin plug-in extension cord 131 with ground and two hot pins.

For comparison, a conventional wiring scheme for a 4-pin 240 VAC plug with electrical cable is shown in FIG. 2A. FIG. 2B is a voltage wave diagram of 240 VAC that plots voltage for the sine wave of power carried by the two hot legs.

Schematic 300 of FIG. 3A and corresponding device drawing FIG. 3B illustrate a first exemplary device 140 with solid state GFCI chip and floating neutral.

FIG. 3C illustrates a related device 150 with NEMA 14-50R combination breaker/plug in context of use.

FIG. 3D summarizes the configuration of devices such as 240 VAC breaker/plug combinations 160 as mounted in a load panel 101.

As shown in schematic 310 of FIG. 3E, analyzing the embodiment of FIG. 3D, a current transformer (CT) coil in the GFCI sub-circuit is monitored by a GFCI chip, and any current imbalance, as sensed by a non-zero current summed over the hot and neutral leads, results in tripping of the GFCI breaker.

The schematic 320 of FIG. 3F depicts a circuit in which the neutral bus of the load panel is wired to a sensor chip for GFCI detection and breaker action.

FIGS. 4A and 4B are views of a 240 VAC breaker/plug device 400 with plug 410 and wiring.

FIG. 4C is a view of device 420 in context of use with a NEMA L14-30P 430, which provides a twist-lock safety feature important for plugs that are frequently connected and disconnected.

FIG. 5A is a view of an alternate embodiment 500 for use with the twist-lock NEMA 14-30P plug.

FIGS. 5B and 5C are top down and side views of the device shown in FIG. 4A.

FIG. 6A illustrates a breaker/plug combination device 600 in use as part of a electric vehicle charging system.

FIG. 6B includes a direct power cable 611 that extends from a plug fitting 612a compatible with an enclosable receptacle 612 in the vehicle 606 to a breaker/plug device 600 mounted in a load panel 101.

FIG. 6C is a block diagram illustrating a breaker/plug device 600 with digital fault detection, watchdog circuit, plug 631 and a common breaker.

FIG. 6D describes a method 650 of charging a battery powered electric vehicle.

FIG. 7A is a view of an alternate 240 VAC breaker/plug device 700 having a modular body construction 701 that includes two conventional breaker units with double-pole throw switch 705 and a lateral body extension built stackwise of breaker body units (701a,701b,701c,701d) and dimensioned to be installed over two more slots on the hot bus bar (a total of four slots).

FIG. 7B is a view of a 240 VAC breaker/plug assembly 720 with two circuit breakers and double throw pole 725 and series wiring to an aviation-type plug receptacle 722.

Taken together, FIGS. 8A and 8B show a dummy breaker body 800 with aviation plug receptacle 801 that may be wired in series with a genuine circuit breaker.

As drawn in FIG. 8C, in another embodiment, the dummy breaker and circuit breaker may be supplied as a single unit 840 and pre-wired in series for convenience in a context of use, here with an adaptor cord For safety reasons, NEMA plug receptacles are not generally flexibly configured for either 120 or 240 VAC so as to avoid inadvertently supplying 240V current to a 120V AC line.

As illustrates another embodiment, FIGS. 9A, 9B, 9C, 9D, 9E and 9F are views of a combination breaker/plug body 900 with plug receptacle 901 in a single-width body that is insertable in a single slot of a load panel.

FIG. 10 shows a circuit breaker/plug combination body 900 in a context of use; here with an adaptor cord 850 that adapts a 4-pin male aviation plug 851 with cord 852 and locking ring 851a to a female NEMA 5-15 receptacle 855.

FIGS. 11A, 11B, 11C, and 11D are perspective and isometric views of a combination circuit breaker/plug body with 120 VAC NEMA 15-5 plug receptacle.

FIG. 12A shows the combination breaker/receptacle device for NEMA 5-15 plugs in a context of use.

FIGS. 12B and 12C are wiring schematics of devices for use with NEMA 5-15 plug receptacles.

FIG. 13 is a schematic of a circuit breaker/plug device wired for 3-phase applications.

FIGS. 14A and 14B are perspective and plan views, respectively, of a 240 VAC 3-phase circuit breaker/plug assembly with aviation-style plug receptacle.

FIG. 15 shows a three-pole circuit breaker/plug device in a context of use.

FIG. 16A shows a 4-pin aviation circular connector in plan view with numbered pin receptacles. The female plug end of the L16-30R AC-adaptor shown in FIG. 16A is drawn in plan view in FIG. 16B.

FIGS. 17A and 17B are views of two adaptor cords having each a short cord with two distinct ends.

FIG. 18 is a view of a grounded circuit breaker/plug body and a “plug-in” 2-prong adaptor.

FIGS. 19A and 19B are perspective views of a modular circuit breaker/plug receptacle combination with user interface.

FIG. 20 is a schematic of a circuit breaker/plug receptacle device with ground fault circuit interrupt, watchdog, user interface, optional datalink, and battery backup.

FIG. 21 is a schematic of a circuit breaker/plug receptacle device with ground fault circuit interrupt, user interface, and datalink.

FIGS. 22A and 22B are views of a modular circuit breaker/plug receptacle combination with solid state components.

FIG. 23 is a schematic with system for radio networking of a circuit breaker/plug receptacle combination.

FIG. 24 is a screenshot of a smartphone software application useful for monitoring and controlling breaker/plug functions during an EV charging session.

FIG. 25 is a system view with breaker/plug serving as a charging station. The device is mounted in a load panel in radio communication with a user's smartphone and an EV. A 240 VAC cord is positioned to connect the EV to the charging station.

The drawing figures are not necessarily to scale. Certain features or components herein may be shown in somewhat schematic form and some details of conventional elements may not be shown in the interest of clarity, explanation, and conciseness. The drawing figures are hereby made part of the specification, written description and teachings disclosed herein.

### Glossary

Certain terms are used throughout the following description to refer to particular features, steps, or components, and are used as terms of description and not of limitation. As one skilled in the art will appreciate, different persons may refer to the same feature, step, or component by different names. Components, steps, or features that differ in name but not in structure, function, or action are considered equivalent and not distinguishable, and may be substituted herein without departure from the spirit and scope of this disclosure. The following definitions supplement those set forth elsewhere in this specification. Certain meanings are defined here as intended by the inventors, i.e., they are intrinsic meanings. Other words and phrases used herein take their meaning as consistent with usage as would be apparent to one skilled in the relevant arts. In case of conflict, the present specification, including definitions, will control.

Unless otherwise defined, all technical and scientific terms used herein have the same meaning as commonly understood by one of ordinary skill in the art to which the subject matter described herein belongs. In case of conflict, the present specification, including definitions, will control.

“Ground leakage” is the flow of current from a live conductor (hot or neutral) to the earth through an unintended pathway. The ground fault is distinguished from the short circuit by the path the electricity takes: in a short circuit, the electricity returns to a local service box or transformer via a ideal conductor such as a wire, and results in a circuit overload fault that trips a breaker, but in ground leakage, the electricity returns to the source via an indirect or alternative path that does not include the safety features built into the local serve box and associated circuitry, and results in a ground fault that trips a breaker only if GFCI is installed in the circuit. Failure to include GFCI in a breaker/plug device creates an unsafe condition in any downstream circuit and load. Devices of U.S. Pat. No. 3,170,744 to Farnsworth, U.S. Pat. No. 3,743,891 to Buxton and U.S. Pat. No. 5,574,612 to Pak, for example, do not design to prevent or test for ground fault conditions.

“Load panel” and “load panel” are synonyms and relate to a service access box that draws power from a grid network and distributes it to a household, business or other end user's facility. In the United States, the line feed is most commonly 240 VAC drawn from a secondary transformer, and includes a center tap that allows the user to pull one of two 120 VAC phases in addition to the single-phase 240 VAC feed. Load panels typically are provided with “slots” for receiving modular circuit breaker units. Slots may take the form described by Nichols in U.S. Pat. No. 7,957,121, or in a variety of commercially available load panels as known in the art.

“Modular circuit breaker unit” refers to an individual breaker, typically of molded body construction, enabled to make hot, neutral and ground connections when mounted in a load panel. The body includes an internal breaker or breakers for disconnecting live feed from a downstream circuit in the event of a fault. The body may be of generally rectilinear form and have a length, a height and a width so as to be compatible with slot dimensions on the bus bars of the load panel, and as such each breaker may be wired into any of the “slots” of the load panel.

A “keyway slot” may also refer to a female receptacle, on the bottom front edge of a breaker body, with an internal connective shoe for receiving and electrically connecting to a blade of a hot bus bar. When the keyway slot is provided without the internal connective shoe, it is termed here a “dummy slot”.

General connection terms including, but not limited to “connected,” “attached,” “conjoined,” “secured,” and “affixed” are not meant to be limiting, such that structures so “associated” may have more than one way of being associated. “Digitally connected” indicates a connection in which digital data may be conveyed therethrough. “Electrically connected” indicates a connection in which units of electrical charge or power are conveyed therethrough.

Relative terms should be construed as such. For example, the term “front” is meant to be relative to the term “back,” the term “upper” is meant to be relative to the term “lower,” the term “vertical” is meant to be relative to the term “horizontal,” the term “top” is meant to be relative to the term “bottom,” and the term “inside” is meant to be relative to the term “outside,” and so forth. Unless specifically stated otherwise, the terms “first,” “second,” “third,” and “fourth” are meant solely for purposes of designation and not for order or for limitation. Reference to “one embodiment,” “an embodiment,” or an “aspect,” means that a particular feature, structure, step, combination or characteristic described in connection with the embodiment or aspect is included in at least one realization of the inventive matter disclosed here. Thus, the appearances of the phrases “in one embodiment” or “in an embodiment” in various places throughout this specification are not necessarily all referring to the same embodiment and may apply to multiple embodiments. Furthermore, particular features, structures, or characteristics of the inventive matter may be combined in any suitable manner in one or more embodiments. For example, it is contemplated that features of dependent claims depending from one independent claim can be used in apparatus and/or methods of any of the other independent claims.

“Adapted to” includes and encompasses the meanings of “capable of” and additionally, “designed to”, as applies to those uses intended by the patent. In contrast, a claim drafted with the limitation “capable of” also encompasses unintended uses and misuses of a functional element beyond those uses indicated in the disclosure. Aspex Eyewear v Marchon Eyewear 672 F3d 1335, 1349 (Fed Circ 2012). “Configured to”, as used here, is taken to indicate is able to, is designed to, and is intended to function in support of the inventive structures, and is thus more stringent than “enabled to”.

It should be noted that the terms “may,” “can,’” and “might” are used to indicate alternatives and optional features and only should be construed as a limitation if specifically included in the claims. The various components, features, steps, or embodiments thereof are all “preferred” whether or not specifically so indicated. Claims not including a specific limitation should not be construed to include that limitation. For example, the term “a” or “an” as used in the claims does not exclude a plurality.

“Conventional” refers to a term or method designating that which is known and commonly understood in the technology to which this disclosure relates.

Unless the context requires otherwise, throughout the specification and claims that follow, the term “comprise” and variations thereof, such as, “comprises” and “comprising” are to be construed in an open, inclusive sense—as in “including, but not limited to.” As used herein, the terms “include” and “comprise” are used synonymously, the terms and variants of which are intended to be construed as non-limiting.

The appended claims are not to be interpreted as including means-plus-function limitations, unless a given claim explicitly evokes the means-plus-function clause of 35 USC § 112 para (f) by using the phrase “means for” followed by a verb in gerund form.

A “method” as disclosed herein refers to one or more steps or actions for achieving the described end. Unless a specific order of steps or actions is required for proper operation of the embodiment, the order and/or use of specific steps and/or actions may be modified without departing from the scope of the present disclosure.

“Processor” refers to a digital device that accepts information in digital form and manipulates it for a specific result based on a sequence of programmed instructions. Processors are used as parts of digital circuits generally including a clock, random access memory and non-volatile memory (containing programming instructions), and may interface with other digital devices or with analog devices through I/O ports, for example.

“Computer” means a virtual or physical computing machine that accepts information in digital or similar form and manipulates it for a specific result based on a sequence of instructions. “Computing machine” is used in a broad sense, and may include logic circuitry having a processor, programmable memory or firmware, random access memory, and generally one or more ports to I/O devices such as a graphical user interface, a pointer, a keypad, a sensor, imaging circuitry, a radio or wired communications link, and so forth. One or more processors may be integrated into the display, sensor and communications modules of an apparatus of an embodiment, and may communicate with other microprocessors or with a network via wireless or wired connections known to those skilled in the art. Processors are generally supported by static (programmable) and dynamic memory, a timing clock or clocks, and digital input and outputs as well as one or more communications protocols. Computers are frequently formed into networks, and networks of computers may be referred to here by the term “computing machine.” In one instance, informal internet networks known in the art as “cloud computing” may be functionally equivalent computing machines, for example.

A “server” refers to a software engine or a computing machine on which that software engine runs, and provides a service or services to a client software program running on the same computer or on other computers distributed over a network. A client software program typically provides a user interface and performs some or all of the processing on data or files received from the server, but the server typically maintains the data and files and processes the data requests. A “client-server model” divides processing between clients and servers, and refers to an architecture of the system that can be co-localized on a single computing machine or can be distributed throughout a network or a cloud. A “cloud host” is a remote server accessible via an IP packet data environment of an Internet network.

### DETAILED DESCRIPTION

The elements, features, steps, and advantages of one or more embodiments will be more readily understood upon consideration of the following detailed description, taken in conjunction with the accompanying drawings, in which embodiments, including details, conceptual elements, and current practices, are illustrated by way of example.

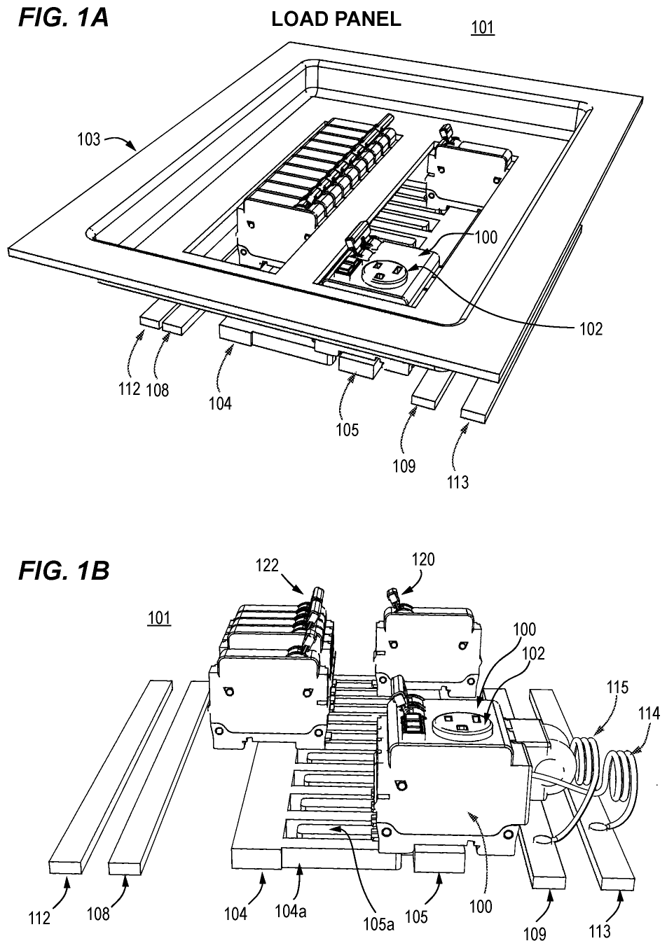

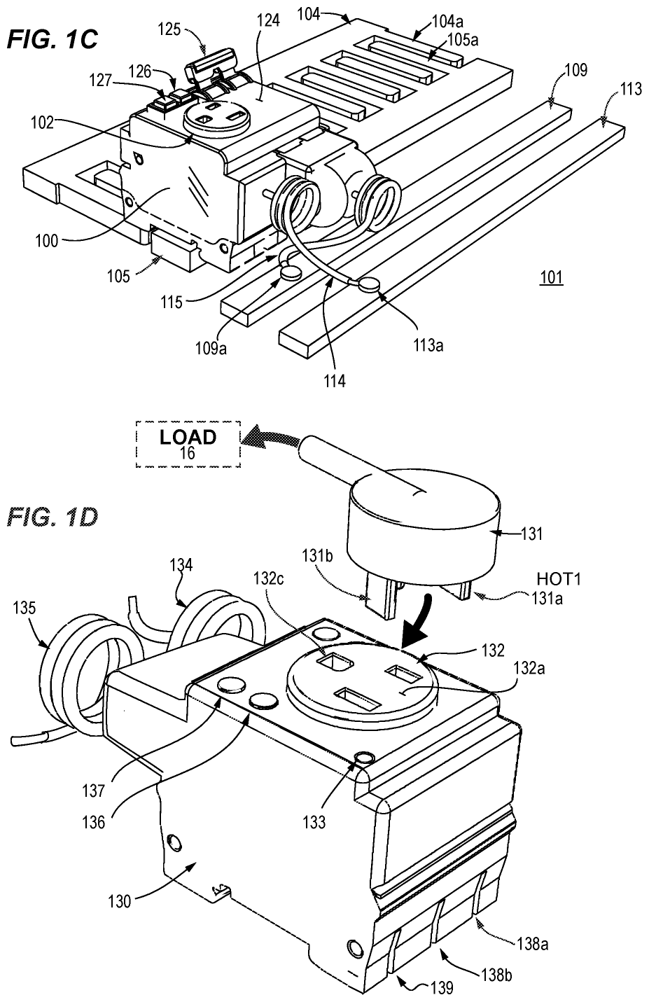

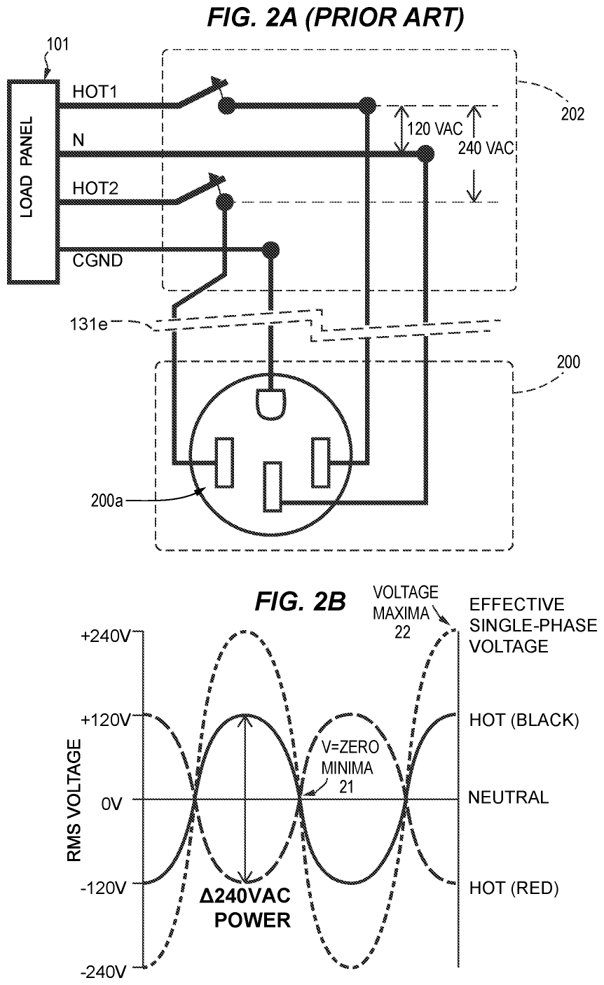

FIG. 1A is view of a first load panel 101 that includes a metal frame 103 and dead cover for wall mounting and typically a hinged door (not shown). A combination breaker/plug device 100 is shown mounted on the bus bars. In this exemplary embodiment, the combination circuit breaker body includes a NEMA 6-50P plug receptacle 102 for receiving a corresponding 6-50R plug (FIG. 1D). Also illustrated in this first exemplary device are TEST and RESET buttons linked to a GFCI circuit inside the device, which occupies three slots on the bus bars. More detail is drawn in FIG. 1C. A bank of conventional 120 and 240 VAC circuit breakers are shown for comparison. The details vary with equipment provided by different manufacturers, but one skilled in the art will understand that the novel concepts can be adapted to the particulars of various load panel suppliers.

For illustration, a schematic representation of the bus bars is provided. Included are two “hot” bus bars (104,105) with interdigitated fins (104a,105a), a right and left “neutral” bus bar (108,109), and a right and left “ground” bus bar (112,113). The geometry and layout of the components will vary with the equipment manufacturer and the country of use.

FIG. 1B shows an open view of the load panel 101 with dead cover removed so as to expose a breaker/plug device 100 with a plug receptacle 102, and its connections to the bus bars. The interdigitated fins (104a,105a) of each hot bus bar are typically connected at the top of the panel to “black” and “red” wires from the street transformer and are of opposite AC phase. Any two proximate fins can supply 240 VAC. Any one hot fin can supply 120 VAC when connected across a load to the neutral. As known in the art, (FIG. 2B) 240 VAC hot connections are made by mounting internal shoe contacts onto adjacent raised slotted blades (not shown) on the interdigitations (104a,105a) of the hot bus bars.

In this embodiment, pigtails for a ground 114 and neutral 115 connection are shown—with wired connections to the ground 113 and neutral 109 bus bars or lugs. “Snap on neutrals” are also known in the art, and are described in U.S. Pat. No. 8,982,539 to Potratz et al, U.S. Pat. No. 9,666,398 to Robinson, U.S. Pat. No. 8,929,055 to Portraz, U.S. Pat. No. 9,824,839 to Watford, and U.S. Pat. No. 10,020,152 to Pearson, for example. The particulars of the embodiment(s) as drawn may be adapted across a variety of available load panel geometries and particulars.

While details may vary, the ground connection made here is a chassis ground from the load and is carried on a green wire within the sheath of the plug cord through the plug receptacle ground pin.

Also shown in FIG. 1B are a conventional single-pole 120 VAC breaker 120 and a pair of double-pole 240 VAC breakers 122 in the upper left corner of the panel. These components are illustrated to emphasize the compatibility of the innovative breaker/plug combination devices 100 with conventional load panels and are not equivalent to the inventive devices. The conventional double-pole breaker device 122 shown in FIG. 1B is provided in a modular body that fits in two slots of the load panel. GFCI is not provided in this simple conventional device, which is installed in millions of households and shops. The breaker may be wired to a remote outlet using three or four-wire ROMEX cable, for instance.

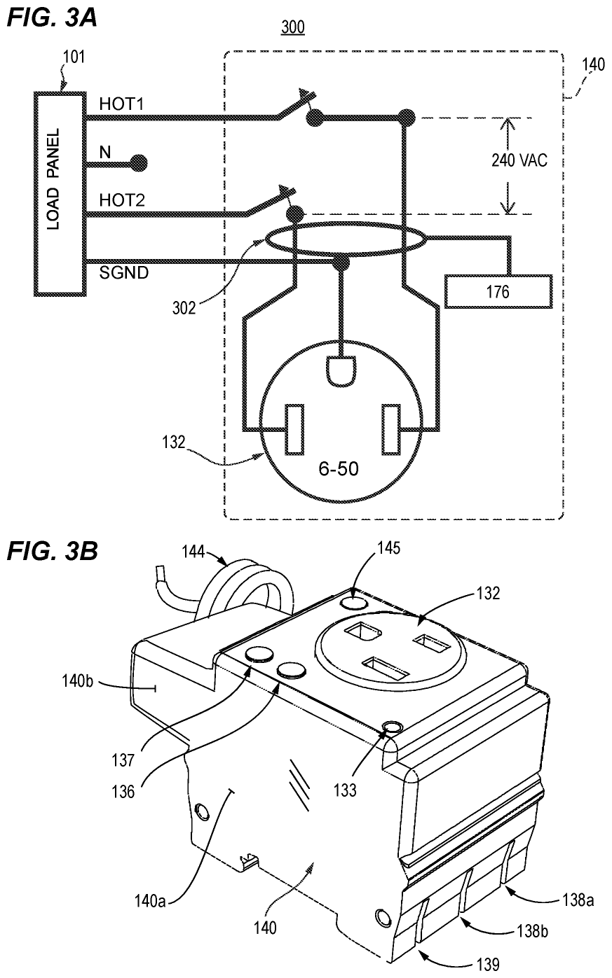

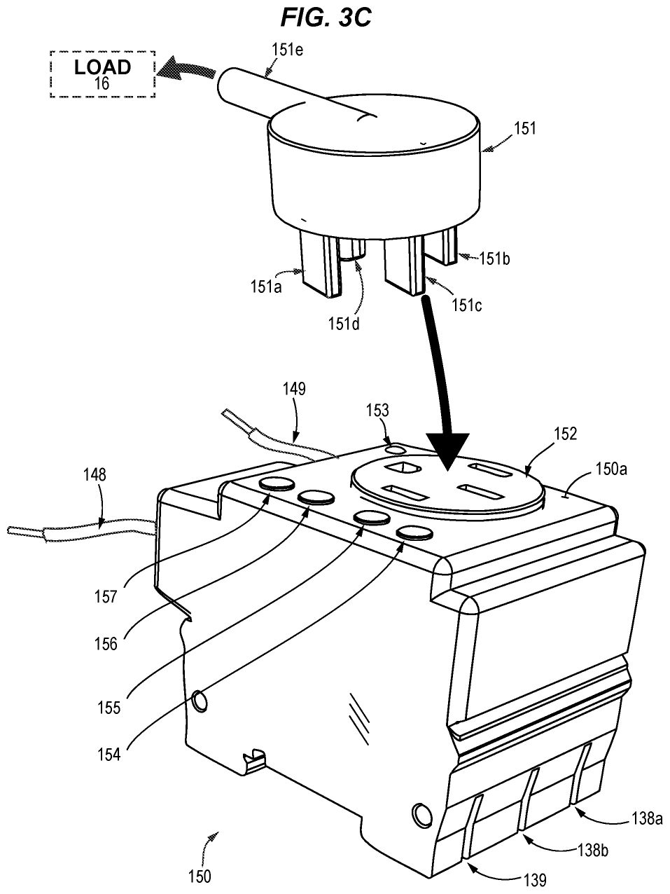

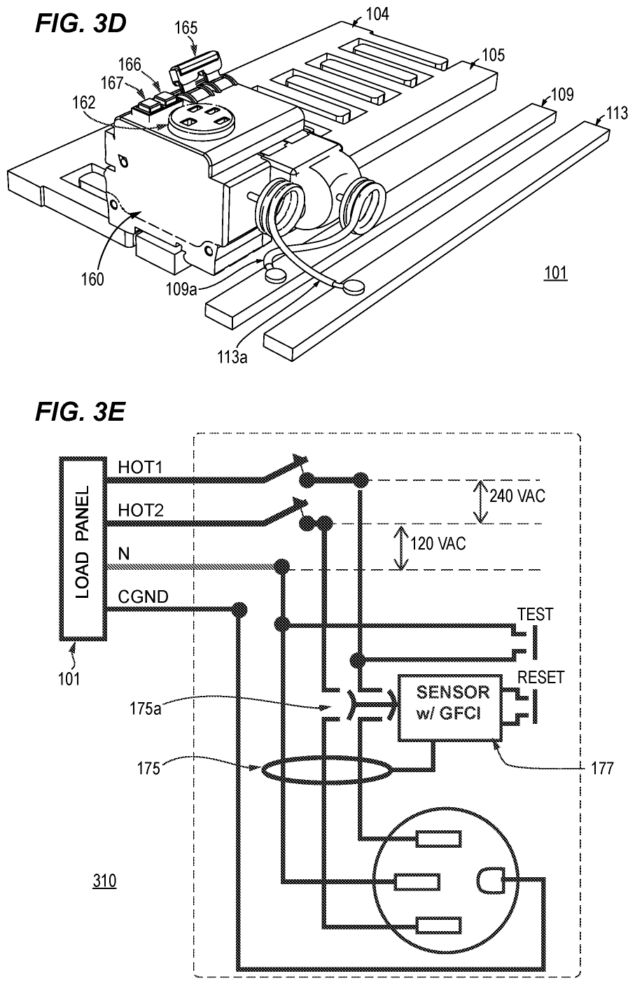

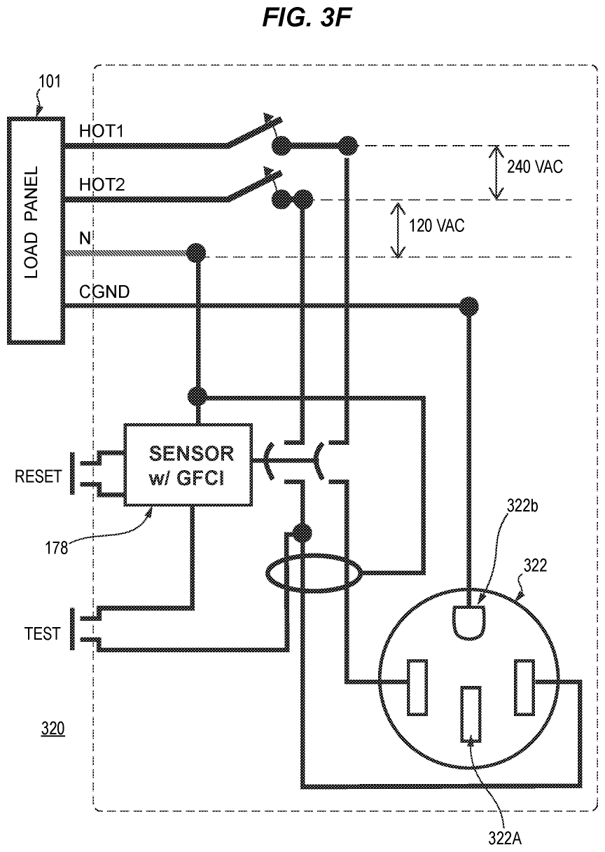

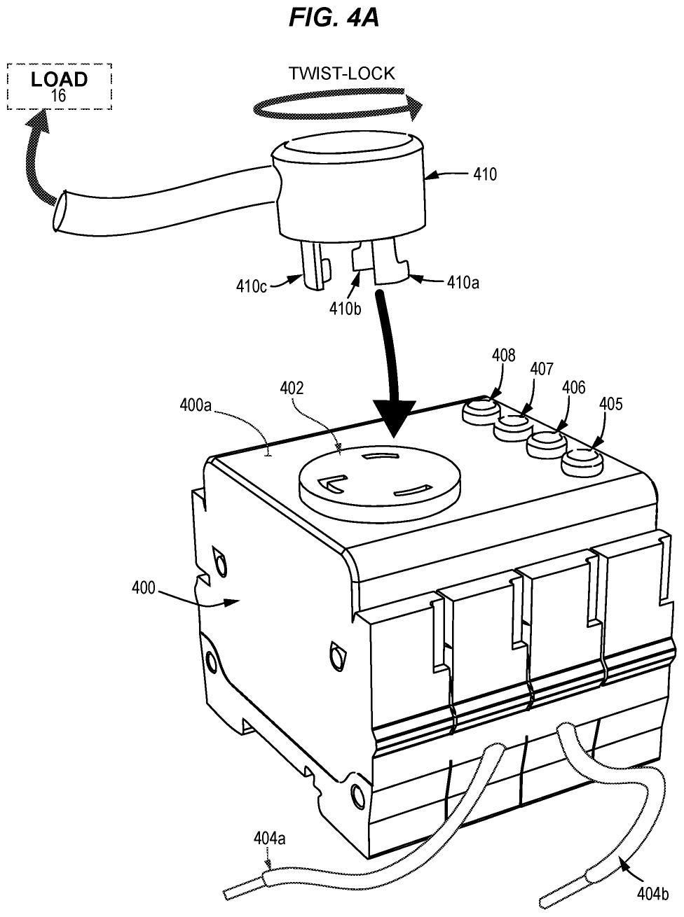

Most panels are specified so that the number of slots is greater than the number of breakers and lines required, as allows for future expansion without the need for a secondary panel. Breakouts or “punchouts” in the dead panel are removed as each additional slot is filled. The breaker/plug devices of the invention may occupy one, two, three or even four slots as needed to support accessory equipment and functions. Not all of the interdigitated fins 104a,105a are live wired within the breaker/plug device, but instead, some keyway slots (139, FIG. 3B) of device 100 may be “dummy” slots so that the device mounts easily in existing load panels and receives one, two, or three phase AC power.

As can be seen from FIGS. 1B and 1C, plug receptacles such as the NEMA 6-50 have larger face diameters 102, almost or about two inches (or greater), and hence require a larger body footprint that occupies a plurality of slots on the bus bars. Exemplary device 100 occupies four slots on the bus bars as drawn, where each slot corresponds to one of the interdigitated fins or “blades” of conventional hot bus bars 104,105. The exposed upper surface of the device body 124 is available for not only a breaker pole 125 or switch, but also the TEST 126 and RESET 127 buttons used in GFCI circuits, and also one or more troubleshooting and status LEDs, for example.

Because GFCI solid state chips are readily available, the larger device bodies may include one or more internal printed circuit boards (PCB) in addition to or in place of the internal electromechanical trip switches and solenoids of conventional breakers, which are not shown here for simplicity. The trend toward integrated circuits in breakers is evident as early as 2004, referencing US Pat. Appl. No. US2005/0105234, for example.

FIG. 1C is a partial view of a load panel 101 that isolates one exemplary breaker/plug device 100 with NEMA 6-50 plug receptacle mounted on the bus bars. The device occupies four slots on the hot bus bar, and engages two HOT blades of opposite phase. The device includes a 2-pole 240 VAC breaker switch 125. This may be substituted with a toggle switch or ON/OFF button in some devices. The TEST 126 and RESET 127 buttons of the GFCI circuit may be lit by internal LEDs that provide status information, if desired. Where RGB LEDs are used, the button-switches may be illuminated with red, yellow or green, depending on circuit status, for example.

The breaker/plug device 100 includes a first wire 114 for connecting the plug ground pin to an earth ground lug or contact within the load panel. Connections to the neutral and ground bus bars are illustrated here as lugs 109a and 113a, respectively. LEDs may signal a correct connection during installation and detect an open ground, open neutral, or other fault during operation.

As will be described in more detail below, neutral wire 115 can be configured in a number of ways. In one instance, it is conductive when plug receptacles are wired for use as 120 VAC outlets (see schematic of FIG. 2A). In another instance it may be conductive as part of a 240 VAC circuit, and used in GFCI detection (see schematic of FIG. 3E). Alternatively, it may be conductive from the load panel neutral bus to a GFCI circuit inside the device, but not to the load (i.e., a “floating neutral”, see schematic of FIG. 3F). Or it may simply be not connected and dispensed with entirely in 240 VAC circuits (see schematic of FIG. 3A and device view of FIG. 3B).

These alternative roles for the neutral connection are considered in more detail below. However, the concern about floating neutrals continues, as evidenced in US Pat. Appl. No. US2014/0312695, where lack of GFCI protection is cited as a hazard amplified by lack of a neutral, and in US Pat. Appl. No US2022/0011381 to Avila, in which a stark warning against open neutrals is described [referencing para 0009-0010]. Thus some detail is needed in considering how integrated circuit innovations can be applied to the problem of ground fault detection.

In contrast to the schematic of FIG. 2A, the panel neutral may be used (see FIG. 3F) as part of a GFCI circuit and chip assembly that detects a current imbalance. The particulars of the neutral connection depend on the configuration of the plug, the load, and the level of the distribution box (i.e., where main box neutral and grounds may be bonded, secondary box neutral and grounds should not be bonded). The discussion of the relative merits of “floating neutrals” and neutral/ground bonding is beyond the scope of this description, but stubbing the neutral does simplify the wiring of 240 VAC circuits and is commonly practiced in the home electric vehicle charging stations having the greatest market share.

FIG. 1D illustrates a 240 VAC breaker/plug device 130 for receiving a 3-pin plug-in extension cord 131e and plug 131 with two hot pins 131a,131b and ground (no neutral). The plug/cord is reversibly connectable to load 16 (bold arrow). Corresponding receiving ports in plug receptacle 132 are shown on surface 132a. Port 132c is configured as a chassis ground. The device 130 also includes status indicator lamp(s) 133 for safe operation and button controls 136,137 for resetting or testing the oveload trip and GFCI function. Leads from the breaker are ground and neutral connectors 134,135, respectively. As indicated with respect to the earlier example, FIG. 1C, the neutral connection may be configured for various uses, including 120 VAC and 240 VAC applications, but in this embodiment, as indicated by the NEMA 6-50R plug receptacle, is intended for 240 VAC use.

This particular device 130 occupies three slots on the hot bus bar. Keyway slots 138a,138b and 139 engage conductive “blades” on interdigitations of the hot bus bars 104a,105a as known in the art for providing two hot phases in alternation. But slot 139 is a “dummy slot” and lacks a hot shoe for making an electrical connection to the hot bus bar. Slots 138a,138b supply HOT1 and HOT2 through the breaker, through the receptacle 132, through plug/cord 131, and to the load 16. Ground port 132c is electrically connected to the ground bus bar via pigtail connector 113a (FIG. 1C) or by an equivalent ground lug. The keyway slot is not a universally used feature for connecting a modular breaker body to a bus bar and other systems have been introduced by other manufacturers both in the United States and in other countries.

The 240 VAC plug receptacle 130 is capable of forming a closed circuit when the circuit breaker is closed and a plug-in load is connected between the hot outlets of the plug receptacle by the insertion of an external electrical plug into the plug receptacle. In this way, when a live load is plugged into plug receptacle 130, the load is powered in series with the breaker such that the breaker will trip if there is a circuit overload, short or fault. Also included is ground fault protection.

For comparison with conventional art, in FIG. 2A, a wiring scheme is shown for a 4-pin 240 VAC plug 200 connected by an electrical cable to a circuit breaker 202 (in which the plug receptacle 200a is not mounted as part of the circuit breaker body). The schematic could suggest that by substituting a suitable plug receptacle, the breaker can be operated with either voltage but proper installation requires that the wiring match the kind of plug provided. For safety reasons, NEMA plug receptacles are not intended to be swappable between 120 or 240 VAC—so as to avoid inadvertently supplying 240V current to a 120 VAC load. A NEMA 5-15R plug receptacle (FIG. 11A) is proper with a breaker of FIG. 2A when only one HOT line is connected across the load to the neutral and a NEMA 14-50R receptacle (shown here) is proper when both HOT lines are connected across the load, for example. The conventional circuit breaker is typically designed to trip if there is a circuit overload or a thermal fault condition.

FIG. 2B will be recognized by those skilled in the art as a standard waveform or “sinusoid” of alternating current (AC) such as is provided to network users in the United States. A step-down transformer at a distribution center provides 240 VAC current, and a center tap at the transformer is used to split the feed into two 120 VAC feeds of opposite phases. Typically these are the “black” and “red” wires that feed into the load panel 101 and are connected at hot bus bars 104,105 to provide HOT1 and HOT2 voltages (FIG. 1D), which may be used separately or are additive. The neutral center tap (zero voltage) is not required to apply 240 VAC single phase current across a load.

The conventional 120 VAC hardwired neutral has long been used in GFCI circuits to detect current imbalance, but a virtual zero-voltage or maximum derivative as detected and monitored by a solid state circuit may also be used to detect ground leakage, as will be described for several of the alternative 240 VAC embodiments here. In some embodiments, the street neutral can be dead ended at the load panel neutral bus, and not pass through the breaker. In these devices, GFCI ground leakage may be monitored by clocking the leading edge of the current/voltage phasor (including real and imaginary components) through short time intervals at one or more derivative maxima and minima of the sinusoid curve and by comparing an expected reference waveform with realtime limiting snippets of dV/dt, dI/dt or the full voltage and and current phasor waveform. This concept is expanded in Nam, 2012 “Single line-to-ground fault location based on unsynchronized phasors in automated ungrounded distribution systems” in Electric Power Systems Research 86:151-157. Also of interest are reports by Zhang, 2021 “A small-sample faulty line detection method based on generative adversarial networks” (Expert Systems with Applications, accessed 23 May 2022 at //doi.org/10.1016/j.eswa.2020.114378), and Liu, 2021 “High Impedance Fault Diagnosis Method Based on Conditional Wasserstein Generative Adversarial Network” (IEEE, accessed at //ieeexplore.ieee.org/document/9676768) in which learning algorithms for recognizing faults in waveforms are used to improve performance as were first implemented at scale in Chinese national networks in 2019. While most end-user devices rely on basic microcontrollers and inexpensive circuits, empirically-derived waveform models (from real data) may be incorporated into firmware in individual breaker devices for fault recognition, with or without the computing power of a digital signal co-processor (DSP) or an on-line server.

Waveform analysis in fault detection and tripping are illustrated figuratively in U.S. Pat. No. 8,929,036 to Nayak, where sample waveforms are shown, and in U.S. Ser. No. 10/020,649 to Du where ground fault waveforms useful for fault detection with microprocessor-based circuits are described. Art related to design of these integrated circuits is discussed in US. Pat. Appl. No. US20170025847 to Armstrong, and enables to the innovation of self-testing fault detectors as described below. The trend to use of microprocessors in breakers continues to derive “smart breaker” technology.

As we transition to electrical energy grids that include more and more smart devices, the field of art must evolve and innovate in order to ensure the highest quality of personal safety. And greater consumer participation in home charging of electric vehicles. The evolution of safety standards is seen in the National Electric Code (NEC) 2020 guidance as provided in non-patent publication titled “GFCI Protection Updates in the 2020 NEC”, published by IAEI magazine (lliaeimagazine.org/features/systems/gfci-protection-updates-in-the-2020-nee, accessed 29 Mar. 2022). Revisions to code sections 422.5 and 625.54 of NEC-2020 update electric vehicle charging systems with regards to GFCI personal protection. A review of GFCI sensor technology is published as “Ground Fault Sensing and Protection” published by NK Technologies (San Jose, Calif.), accessed on 16 May 2022 at //nktechnologies.com/engineering-resources/ground-fault-sensing-and-protection/. Schneider Electric (Rueil-Malmaison, France) has published a white paper on ground fault protection titled “4 Essential Ground-Fault Protective Schemes You Should Know About”, accessed 25 Jan. 2022 at //electrical-engineering-portal.com/ground-fault-protective-schemes. It is clear from these reviews that this field continues to evolve.

In operation, a ground fault can occur via a manual or an automatic self-test, or an actual ground fault, for example when a person comes into contact with the line side of the AC load and an earth ground at the same time. Circuitry is intended to differentiate a test from an actual fault, while not tripping the breaker for a test, and to ensure that an actual fault can be detected even while doing a test.

The basics of ground fault detection using one, two or three CT sensing toroids as have been reduced to practice are evident in sample patented devices that are marketed by RS Components, Allied, Schneider, Square D, Siemens, Legrand, Delixi, Eaton, Omron, Leviton, General Electric, Cadence, ABB, Astrodyne, Berthold, Murray and others, while not limited thereto. In the United States, these devices are generally in compliance with accepted standards as tested by Underwriter's Laboratories, Inc. Similar worldwide standards exist. A few of the numerous patent disclosures will be cited here as representative art, and incorporated in full by reference for their teachings. The gist of this art is the use of “sense coils” as analog inputs to digital chips such as the Fairchild FAN4149, NCS37010, NCS37010 (ON Semiconductor, San Jose Calif.), the PIC12F675 manufactured by Microchip (Chandler, Ariz.), the AFE3010 (Texas Instruments, Houston Tex.); micro-solenoids such as those produced by Bicron Electronics (Canaan, Conn.) and the RV4141A GFI (Fairchild Semiconductor); more modern devices such as featured in U.S. Ser. No. 10/804,692 to Kennedy, U.S. Ser. No. 11/283,255 to Yang, and US20200185905 to Cairoli—and associated microelectronic components too numerous to list. Interestingly, the NCS3701 from ON Semi includes a digital signal processor (DSP) that can be used to “fingerprint” fault signals and the ATmega328P (Atmel, San Jose Calif.) includes an on-chip comparator for detecting transient deviations from a nominal sinusoid waveform.

Representative patent art related to miniaturized digital fault sense circuits from the collections of the US Patent Office includes, but is not limited to, U.S. Pat. No. 8,085,516 to Armstrong, U.S. Pat. No. 8,547,126 to Ostrovsky, U.S. Pat. No. 9,899,260 to DeBoer, U.S. Ser. No. 10/020,649 to Du, U.S. Pat. No. 7,149,065 to Baldwin, and U.S. Pat. No. 6,137,418 to Zuercher, and applications US20190096598 to Schmalz, US20170025847 to Armstrong, US20090147415 to Lazarovich, and US20210135452 to Roberts, for example. In the event of a fault, a microprocessor causes the breaker to trip, and also may cause an alert through a radio, a light such as an LED, or through an annunciator such as a buzzer or speaker.

With microelectronics, dual-function breakers are achieving increasingly widespread use, and are described for example in U.S. Pat. No. 8,159,318 to Yang, US Pat. Appl. Nos. US2005/0105234 to McCoy, US2015/0062769 to Rico, U.S. Pat. No. 6,052,046 to Ennis, and in a non-patent publication titled “Dual Function AFCI/GFCI Circuit Breaker” accessed 20 Apr. 2022 at usa.siemens.com/afci, for example. US Pat. Appl. Publ. US2021/0135452 demonstrates the level of miniaturization that has been achieved, while still using the older FAN4140 GFCI chips and an SCR switching relay.

With suitable clock accuracy and analytical electrical circuitry, the level of sensitivity to ground fault meets the threshold 5 mA GFCI standard and response time (20 msec) required for code, even if the neutral line is dead-ended at the breaker. For example, EV chargers currently on the market do not use a neutral connection at the load to establish a GFCI threshold, but are approved for use in home and commercial applications.

Solid state detection and interrupt of arc faults is also readily achieved, and in more recent advances, Atom Powers (Huntersville N.C.) has commercialized solid state breaker technology that is UL approved and can replace electromechanical breaker devices for overload, arc and ground fault. See U.S. Pat. No. 10,804,692 to Kennedy, and U.S. Pat. No. 8,503,138 to Demetriades, U.S. Pat. No. 8,891,209 to Hafner, for example. These breakers are significantly improved over the thyristor-type solid state circuit interruptors disclosed in U.S. Pat. No. 4,631,621 to Howell and US. Pat. Appl. No. US2020/0195905 to Cairoli, for example. Second generation improvements are described for example in US Pat. Publ. Nos. US2021/0066013 to Kumar and US2021/0126447 to Miller, et seq. In future devices, a single solid state breaker may be adapted as a universal circuit interrupt when paired with digital circuitry for detection or prevention of overload, thermal overload, surge arrest, arc, and ground fault conditions in need of a power interrupt.

Schematic 300 of FIG. 3A and corresponding device drawing FIG. 3B illustrate a first exemplary device 140 with solid state GFCI capability and floating neutral configured with a NEMA 6-50R plug receptacle 132. The overload breaker may serve as a multi-function GFCI and AFI breaker, or optionally, a series breaker switch is used for GFCI and AFI in which a dual GFCI/AFI fault circuit is housed in the projecting end 140b of the molded body 140a and the overload breaker is housed in the more conventional modular “front end” of the body. A secondary coil of a current transformer (CT) linked to magnetic toroid 302 reads induced current and supplies this signal to the GFCI chip 176. Only when the current in the HOT1,HOT2 leads is imbalanced is there a residual or differential current that charges toroid 302. The differential current can also be mapped as a deviating phasor waveform as can be read by a microprocessor to detect and/or diagnose a circuit fault, as will be described below (Equation 1).

The approach illustrated in FIG. 3B supports a plug receptacle 132 specific for 240 VAC in which two hot leads are connected to the load as shown in FIG. 3A. Here a NEMA 6-50 plug receptacle is again illustrated and is mounted on a broad-width molded body that occupies three slots in the load panel. A chassis ground 144 is provided as an essential element of personal protective equipment in these kind of plug-in circuits. Connection to earth ground may be made at the level of a secondary box or at the mains box, where it is termed a “system ground” and may be joined to the neutral street feed. Note the absence of a neutral connection in the plug receptacle and the absence of a neutral “pigtail”, which distinguishes this drawing from FIG. 1D.

The device 140 includes three keyway slots for engaging the hot breaker bar fins; one of which is a dummy slot 139 that does not include a connectable electrical contact. The other two slots 138a,138b connect to opposite phases HOT1 and HOT2 respectively.

Device 140 utilizes the larger surface area on top of the breaker and microelectronics to include improved control and diagnostic features in the package, essentially those of FIG. 1D, including a solid state TEST and RESET switches 137,138, and status LEDs 133 and 145.

FIG. 3C illustrates a related device 150 with NEMA 14-50R combination breaker/plug in a context of use. The plug 151 is a four-prong plug and inserts (bold arrow) into the plug receptacle 152 in the breaker/plug combination device 150. The plug includes a HOT1 prong 151a, a HOT2 prong 151b, a NEUTRAL prong 151c and a GND prong 151d. The plug connects via a flexible cord 151e to a LOAD. Neutral connection 148 from the load is made to the neutral bus of the load panel. Ground 149 connects ultimately to earth ground, but is shown here as a chassis ground and connects to the ground prong 151d when the plug 151 is inserted in the receptacle 152, a feature unique to the combination breaker/plug devices of the disclosure.

Breaker/plug device 150 body includes a broad-width user-accessible face 150a on which are mounted four multi-function buttons or indicator lights that serve for test and reset of the overload and GFCI breakers and as status indicators. Each button includes a status LED, where red indicates a problem and green indicates operative normal. Button 157 is spring-loaded, and has a raised position when the breaker is tripped and a recumbent position when the breaker is conductive and the plug 151 is live. This button control 157 may alternatively be a toggle bar or a rocker switch, but controls both poles when wired as a double-pole 240 VAC device. LED 156 is an RGB LED and in combination with LED 153, indicates that the device is wired correctly and has passed all self tests. Button switches 154 and 155 are spring loaded and serve as TEST and RESET controls for the GFCI breaker circuit within the body. This device is wired generally as shown in FIG. 3E with functional neutral and ground connections to the load panel. The hot connections are made in keyway slots at the anterior front bottom edge of the device and include one dummy slot and two hot slots with hot shoes for connection to HOT1 and HOT2 as described above with respect to the device shown in FIG. 3B; these slots are numbered 139, 138a and 138b respectively.

FIG. 3D summarizes the configuration of devices such as 240 VAC breaker/plug combinations 160 as mounted in a load panel 101. The wiring is done essentially as shown in FIG. 3E and includes a GFCI chip operatively coupled to plug receptacle 162. HOT1 and HOT2 connect to hot bus bars 104,105 analogously to the layout shown in FIG. 1C. Also included are neutral and ground connections 109a and 113a. The body of the device includes a NEMA 14-50R plug receptacle, a double-pole throw switch 165, and a TEST and RESET button (166,167 respectively) for the GFCI interrupt, for example. These features are also illustrated schematically in the accompanying wiring diagram.

Of particular interest in detecting fault characteristics in a sinusoid waveform are current sensing toroids (CT) magnetically coupled to current in wires passing through the toroid, and associated sensing coils wrapped around the CT toroid. The sensing coils provide a non-zero output to a microprocessor with A/D converter and/or DSP when residual current is detected.

As shown in schematic 310 of FIG. 3E, analyzing the embodiment of FIG. 3D, an inductive coil in the GFCI sub-circuit is monitored by a GFCI chip 177, and any current imbalance, as sensed by a non-zero current summed over the hot and neutral leads, results in tripping of the GFCI breaker 175a. The GFCI chip is an integrated circuit. Fault current through the neutral causes a voltage in a sense coil wrapped around toroid 175 that is amplified with positive feedback and produces an oscillation. If the oscillation persists longer than a specified time delay, the SCR triggers an interrupt that disconnects the hot wires. An early GFCI circuit with a single sensor and amplification coil is described in U.S. Pat. No. 3,745,414 to Frantti and includes a solenoid for tripping a dedicated double-pole breaker when ground fault leakage is detected. The sense coil architecture can also be seen in U.S. Pat. No. 8,085,516 to Armstrong. The ground pin of the plug receptacle is a chassis ground and connects to the conductive surfaces of the load where a ground fault could be conducted through a person.

The schematic 320 of FIG. 3F depicts a hybrid circuit in which the neutral bus of the load panel is wired to a coil and sensor chip 178 for GFCI detection and breaker action. The GFCI sensor is depicted as a microelectronic circuit and is in direct linkage with a microbreaker. The neutral lead need not continue to the load, and as shown here, the neutral slot 321 of the plug receptacle 322 is not connected (open neutral). In this instance, the sensor coil of the GFCI circuit is mounted around the two hot leads and senses current as a sinusoid with an effective single phase voltage of 240 VAC (FIG. 2B). Neutral plug slot 322a is part of a “floating neutral”. As before, the chassis ground s electrically connected 322b through the plug receptacle to the load panel. The patent literature includes descriptions of floating neutral breaker devices. Conventional devices that display this feature lack a plug receptacle but may include microprocessor-based GFCI and AFI protection, for example as described in U.S. Pat. No. 9,899,160 to DeBoer. U.S. Pat. No. 9,899,160 teaches a thin device having less than a two inch duplex slot width, as would not readily be compatible with the 240 VAC plug receptacles of the inventive devices.

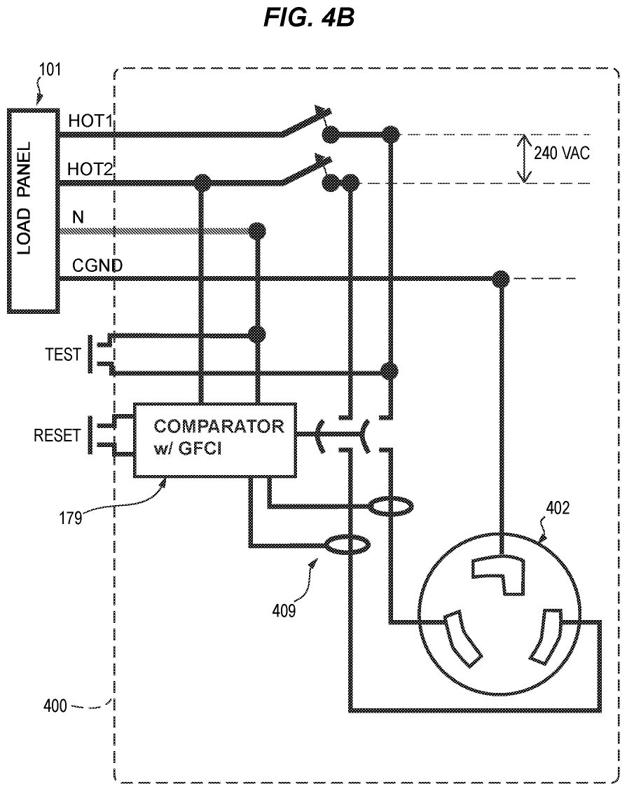

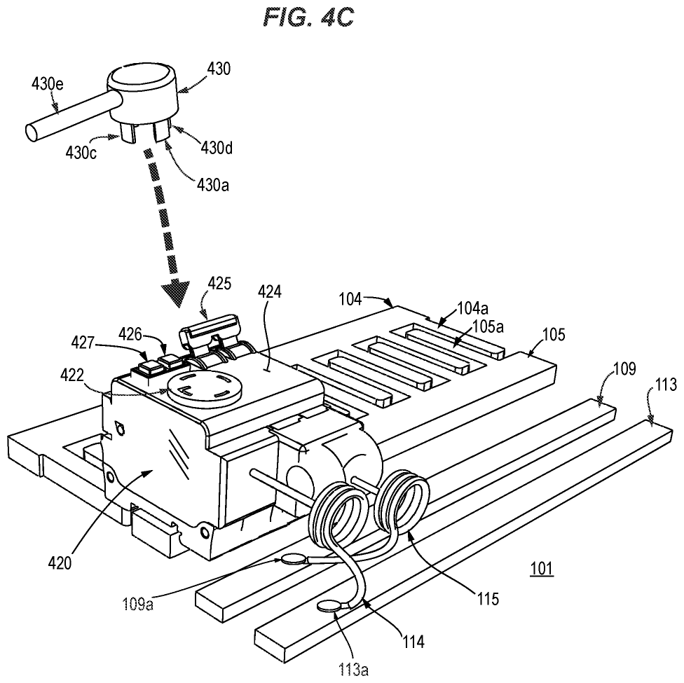

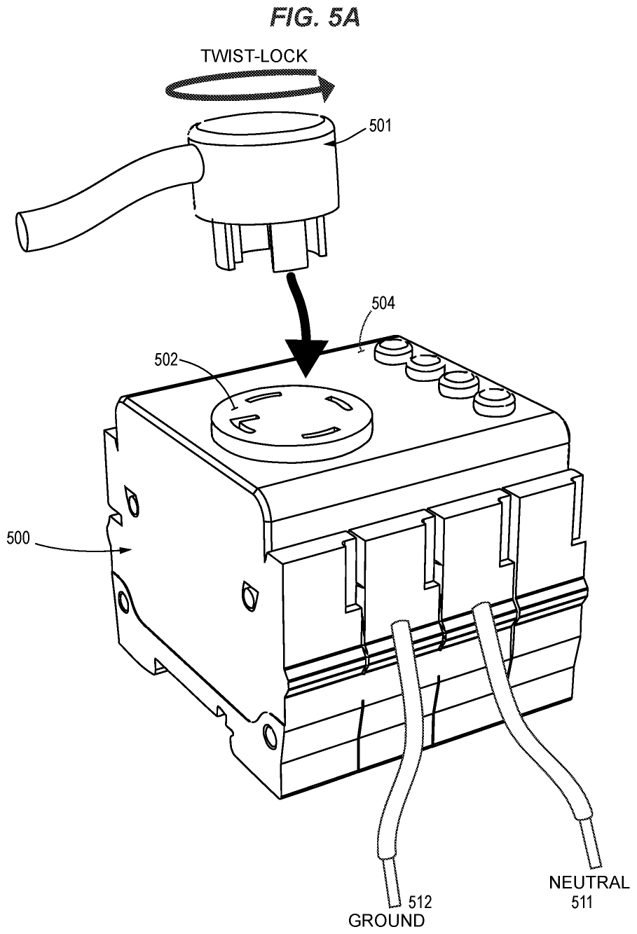

FIGS. 4A and 4B are views of a 240 VAC breaker/plug device 400 with plug 410 and wiring in a context of use (bold arrow). The exposed top face 400a of this device, which occupies four slots in a load panel, includes a twist lock NEMA L6-30R plug receptacle 402. The pins of the mating plug 410 are marked as HOT1 410a, HOT2 410b and GND 410c. Corresponding circuit elements are indicated in the accompanying schematic (FIG. 4B).

The GFCI sensor in this example includes a pair of sense coils 409 and a comparator chip 179. Current in the two hot wires is compared, optionally with a reference signal, and any deviation from nominal is programmed to cause the breaker to trip. The comparator 179 of FIG. 4B may include an A/D converter and low jitter clock that evaluates the phasor vectors and assesses the impedance by breaking out resistance and reactance so as to model any pseudo-resistance component in the impedance that derives from a ground leak (Equation 1). In a 60 Hz system, the sampling rate may approach or exceed 240 times per second, and is adequate to achieve a ˜3 msec response time.

The minimal wiring of the device (snap-on hot bus bar plus chassis ground wire 404a and neutral 404b) allows for simplified installation. In one instance, the neutral wire can be used as part of a test circuit for simulating a ground fault without a connection to the plug/load. Color coding of the ground wire and instructions for installation serve to minimize wiring errors. Top face-visible status indicators confirm a correct installation. The status indicators are integrated with active breaker trip and reset control hardware, shown here as multifunction illuminated button switches, and include LED display of fault conditions such as open ground, ground fault and arc fault, for example. Shown are a RESET switch 405 for a GFCI circuit, a manual test switch 406, a selectable fault status indicator 407, and a spring-loaded button-type overload RESET and CUTOFF switch 408. CUTOFF is achieved by pressing on the button 408 to release it from a depressed-hot condition, and an indication that the circuit has been inactivated is provided by a blinking LED to indicate that the wiring downstream from the breaker is dead. The internal circuitry is provided with Vcc=5 mA is supplied from a rectifier and power management chip. Of course, other configurations are readily implemented.

Use of twist-lock NEMA plug 410 provides an increased level of personal protection. Plug receptacles used with bayonet plugs are known to lose their grip with repeated plugging and unplugging. In some instances, slippage becomes evident after only a hundred or so manual cycles. Given that an EV user may plug in a vehicle at the end of each day for several years, the need for a twist-lock plug is evident. This plug is compatible with Class 2 EV chargers.

All features are implemented by a printed circuit within the breaker body 400 and may be communicated using Bluetooth radio to a remote household hub or other smart device operated by an end user or technician. Where waveform fault detection circuitry is implemented in the device, the sinusoid AC wave can also be directly monitored and displayed by an oscilloscopic display on a smartphone downloadable “app” to aid in troubleshooting and maintenance. This level of skilled user access is needed to support more complex devices and systems such as those in which DC charging from photovoltaic-to-EVs is coupled to local energy storage banks (battery walls) and one or more invertors or generators for power saving and emergency backup, and is part of the “smart breaker” features that may be implemented here.

In FIG. 4B, the neutral (N) is shown to be wired to the breaker/plug device 400, but not to the plug receptacle 401, which may be a true floating neutral or may be bonded to ground/neutral at the mains 101. Here, the GFCI circuit can be tripped by a microprocessor if a DC leakage to ground is detected in the phasor calculations without reference to a CT over a neutral-to-load connection. The components of the phasor wave diagram cannot be represented as a two-dimensional wave drawing, but are calculable as a three-dimensional “corkscrew” phasor pattern (with real and imaginary parts) clocked to and synchronized with the incoming AC waveform and minimum and maximum crossings at each half wave. While not bound by theory, and at a conceptual level, consider that the imaginary component of the phasor diagram can be quantitated in essentially real time by digitizing the reactance during the crossover of the voltage across zero volts, when crossing the maximum in the peak voltage, and when crossing the corresponding minima and maxima of the current flow. Viewed as a phasor wave, multiple reference points occur in each cycle when sampled at the 0 and 1 derivatives of voltage and current. In one option, the neutral may be hardwired in the AC circuit as a reference and for return of excess current, or in another option may be a virtual neutral (i.e., not hardwired to the downstream load) that is useful purely as a reference having a zero voltage minimum (FIG. 2B, 21) and corresponding derivative in the phasor diagram (not shown) at the crossover. Similarly, the voltage maxima (FIG. 2B, 22) serve as another reference point in the first and second derivatives of the sinusoid curve. The corresponding plots of current I also show inherent minimum and maximum reference points useful in waveform analysis. From an analysis of the phasor wave around any of the reference points, any bias and discontinuities in the waveform around the minima and maxima of the sinusoid (FIG. 2B) are diagnostic of a fault. Impedance Z in equation (1):

dZ/dt=R+Rᵢ−R*(written in the vector notation of a phasor matrix) (1)

where R is the real component resistance, R, is the imaginary component reactance, and R* is ground leakage (written as a negative resistance), carries fault information that can be extracted from the minima and maxima of the phasor sinusoid as reference points when executed by microprocessors equipped with a reasonably low jitter clock. This insight may represent an advance in the art for small end-user circuit breaker electronics. Similar analyses may be useful in detecting overvoltage and undervoltage, arc faults, and also ground leakage from hot to ground. In a practical application, the breaker/plug device may include a phasor waveform analyzer circuit comprises a low-jitter clock, an analog-to-digital sampling circuit, and a digital signal processor with memory for storing fault signal patterns and representative operating characteristics coupled to an interrupt switch for disconnecting power if a fault is detected. The memory may be supplied with a pre-loaded library of fault signal patterns, may be accessible by a network server, and may receive an updated library from the network server after analysis of stored data by a remote learning machine.

FIG. 4C is a view of device 420 in context of use with a NEMA L14-30P 430, which provides a twist-lock safety feature important for plugs that are frequently connected and disconnected. The plug is a four-prong 240 VAC plug, and includes HOT1 430a, GND 430c, and Neutral 430d. The fourth pin, the HOT2 line, is evident on the face of the plug receptacle 421 but the perspective view does not permit its labelling on the plug. This plug is compatible with a class 2 EV charger.

Features of the load panel 101 were described earlier with respect to FIG. 1C. Unlike the embodiment 400 of the previous figure, in which the neutral is part of the CT differential sensor transformer, the breaker/plug device 420 with L14-30R plug receptacle, may include a load neutral that extends through a four-wire cord or cable 430e. And in accordance with personal protection standards for electric vehicles, the ground pin of the plug may be dimensioned so that the hot leads disengage from the plug receptacle before the ground pin loses its contact, for example.

On the top face 424 of the device, plug receptacle 421 is exposed to receive the plug 430 (bold arrow), and the face has space for a breaker bar 425 (or other switch mechanism), TEST and RESET buttons (426,427) and optionally status indicators such as LEDs. The device differs from embodiment 400 in that the ground wire 114 and neutral wire 115 both connect from the plug receptacle 422 to the respective ground and neutral bus or lugs of the load panel 101. Lug 109a represents a conductive connection to the neutral bus bar and lug 113a a conductive connection to the earth ground, which may be bonded to neutral, generally at the level of the primary mains box. Features of neutral connections in 240 VAC power supplies and breakers have been discussed earlier.

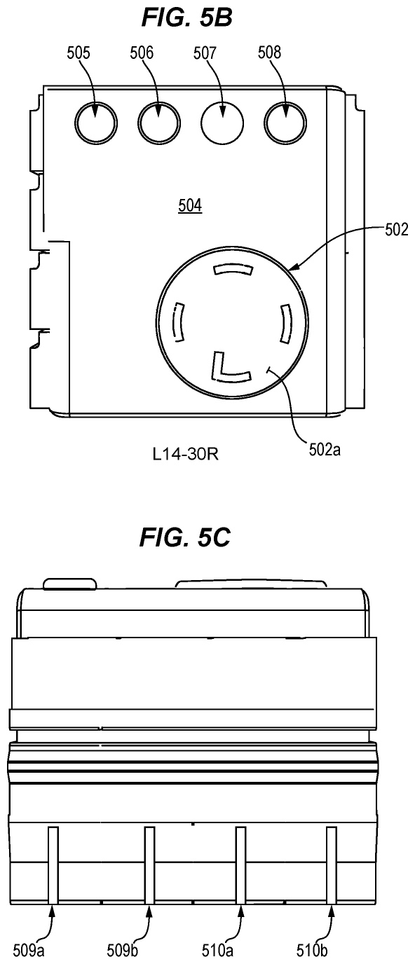

FIG. 5A is a view of an alternate embodiment 500 for use with the twist-lock NEMA 14-30P plug 501. The unit includes neutral 511 and ground 512 connections from the plug receptacle 502 to the respective ground and neutral bus or lugs of the load panel 101 as discussed earlier, but also includes a more streamlined top face 504 with operator controls and the exposed plug face not unlike those features illustrated in FIGS. 3C and 4A. These 30 Amp 240 VAC devices are all useful as part of Class 2 EV charging systems and provide the added safety of a twist-lock plug.

FIG. 5B is a top down view of operator-accessible surface 504, and is related to the device control design shown in FIG. 4A, in which top face status indicators confirm a correct installation and operational status. The status indicators are integrated with active breaker trip and reset control hardware, shown here as multifunction illuminated button switches, and include LED display of fault conditions such as open ground, ground fault and arc fault, for example. Shown are a RESET switch 505 for a GFCI circuit, a manual test switch 506, a selectable fault status indicator 507, and a spring-loaded button-type overload RESET and CUTOFF switch 508. CUTOFF is achieved by pressing on the button 508 to release it from a depressed-hot condition, and an indication that the circuit has been inactivated is provided by a blinking LED to indicate that the wiring downstream from the breaker is dead. Of course, other configurations are readily implemented and substitution of one NEMA plug receptacle 502 for another can be done while using the same molded body of the device. Internal wiring connects the pin receptacles of the plug face 502a to the circuit breaker and external electrical connections. An internal printed circuit board operates the fault detection circuits, interrupts, and indicator systems of device 500. A radio interface such as Bluetooth may be implemented if desired so that the devices can be networked.

Interestingly, a USB port may be provided on the user-accessible surface of the breaker (or dummy breaker body). The USB port may be powered for example by an STM8S00373 chip (ST Microelectronics, Geneva CH) may serve multiple uses. In a first use, a gooseneck LED lamp may be inserted to provide close illumination of the load panel, with or without removal of the dead panel cover. In a second use, a service cable may be inserted into the USB port to download operating status and fault history data, or to display more detailed information, such as a visual representation of the sinusoid, or to reconfigure the breaker from one wiring schematic to another, such as by plugging a receptacle plug into a contact matrix in the receptor body, and by a microcontroller, recognizing the plug so as to route the appropriate line fees and buses to the appropriate prongs and pins. The service cable can also be used to test components of the breaker circuitry. The USB port can be a USB-A or USB-C port, for example.

FIG. 5C is a side view of device 500 and illustrates the bottom front keyway slots or “clefts” with connective “shoe” needed to snap-fit the device over powerable surfaces and/or raised blade contacts onto a typical hot bus bar. Two of the slots 509a,509b are provided with contact shoes to make a live connection to the HOT1 and HOT2 contacts of the plug; two of the slots 510c,510d are dummy slots and are needed simply so that the device is compatible with existing load panels such as offered by multiple manufacturers. Other load panels use different systems, and the devices 500 may be adapted accordingly without sacrificing the modular characteristic of the breaker/plug body.

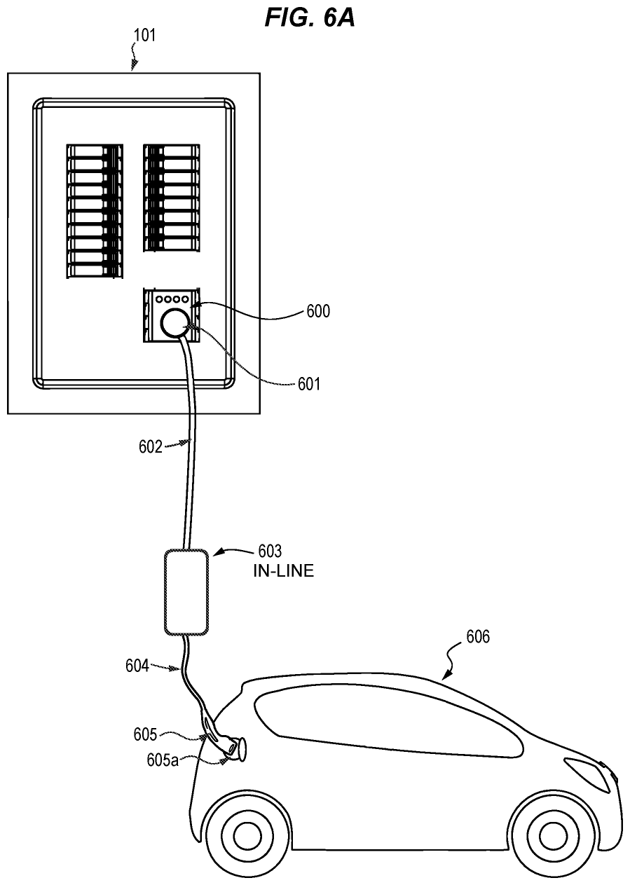

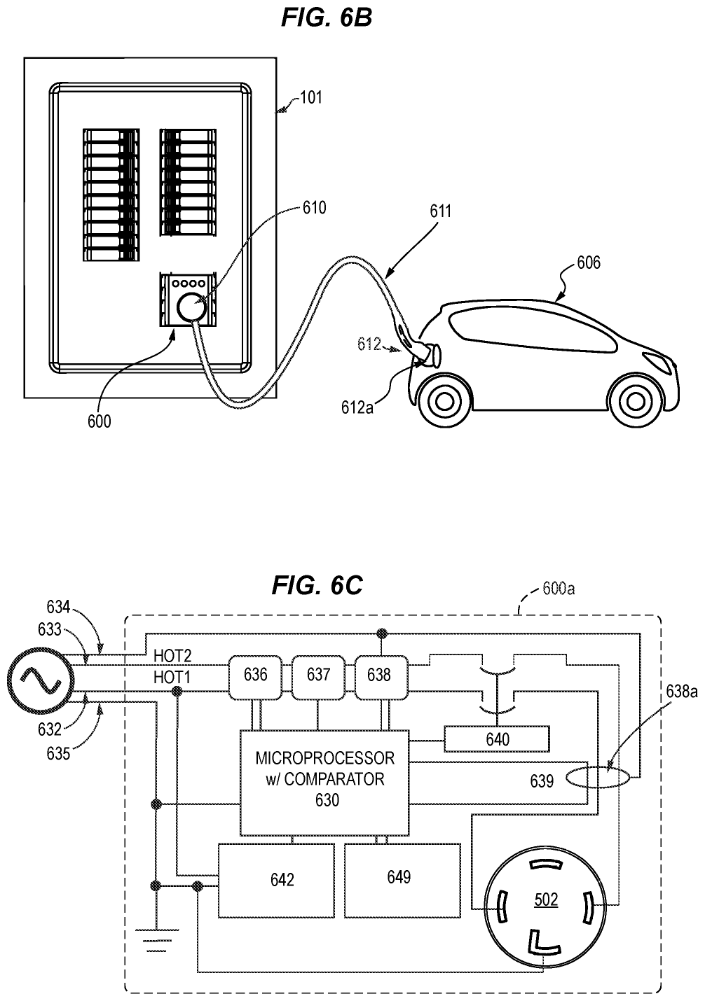

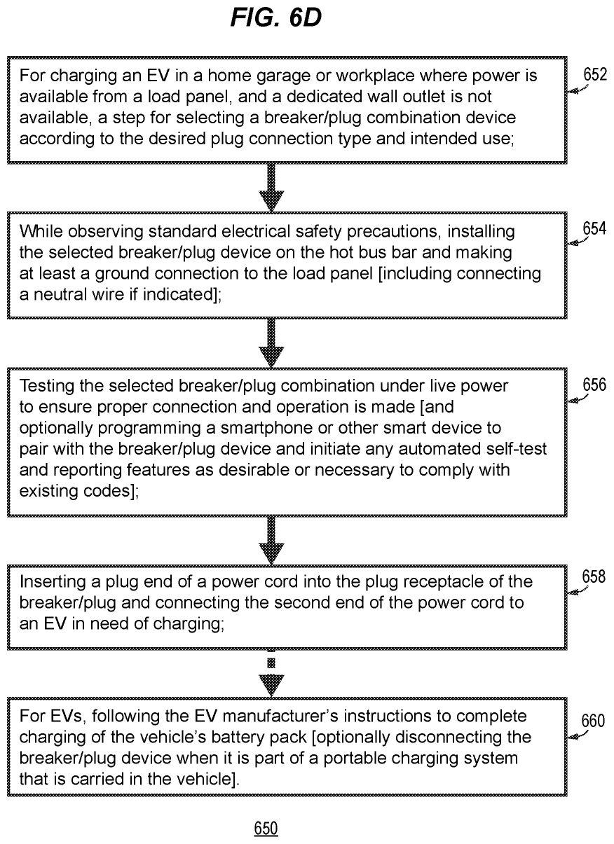

FIG. 6A illustrates a breaker/plug combination device 600 in use as part of a electric vehicle charging system. A breaker/plug device 600 (for example) is installed in a load panel 101, and a male plug 601 is inserted into the plug receptacle as demonstrated in FIG. 5A for instance. The male plug includes an adaptor cord 602 that connects to an in-line connector box 603. Cord 604 with female end-plug 605 and handle are configured to seat in a plug receptacle 605a in the EV 606, which connects to internal components for regulating the charging process for an internal battery and “always on” vehicular functions.

To this end, the EV 606 may communicate with circuitry in the in-line connector box 603. Data and control signals may be carried via a modulation and demodulation of the AC carrier wave as known in the art, typically at 1 kHz. Charging optimization and speed are controllable by the vehicle through an on-board charging module (OBCM) with step-up transformer and rectifier engineered to recharge the battery at a selectably controllable rate that can be optimized for battery life or for “fast charging”. The OBCM will also include means for coordinating the charging conditions according to the available power and means for displaying charging status to the user, optionally with some level of selectable control. Device 600 may be designed with internal circuitry that taps into the OBCM data stream and adjusts its charging features accordingly.

In practice, a display screen may be included in an OEM in-line connector 603. Connector box 603 may also include digital logic components and watchdog circuitry, including failsafe breaker components, depending on the manufacturer. The adaptor cord 602 may be reversibly disconnectable from the in-line connector box 603 and a family of one or more adaptor cords may be supplied with various acceptable plugs 601 for flexibility in use devices 600 having alternate plug receptacle configurations such as NEMA 14-30R, 6-50R, L16-30R or L16-50R if desired.

The in-line connector is optionally wall-mounted, but in some instances the plug adaptor 602 and connector box are portable and are designed to be swapped out for various plug units 601 in which the in-line connector 603 is nothing more than a junction box with cord 604 that can be stored in the trunk of the vehicle so that it is always available whenever the vehicle is in need of a charge, even when the driver is not at home. Drivers may carry a variety of plug adaptors 602 as needed to improvise when the available plug outlet is not a NEMA 14-30R (or a 6-50R), for example. Mileage per hour of charge may suffer if 30-50 A 240 VAC is not available, but some capacity to recharge is preferable to none.

FIG. 6B includes a direct power cable 611 that extends from a plug 612 compatible with an enclosable plug receptacle 612a in the vehicle 606 to a breaker/plug device or assembly 600 in load panel 101. This configuration is made possible by installing breaker/plug device 600 (for example, or any of the breaker/plug device embodiments shown here) in the load panel and by removably inserting plug 610 into breaker/plug device 600. For reference, a 3D view demonstrating a step for inserting a charging cable (bold arrow) is shown in FIG. 5A.

In this instance, the device 600 may include accessory circuitry specific for EV charging. The device 600 may also provide radio reporting of status to a smartphone, for example, or even control of the EV charging process via a radio link. The device does not replace internal circuitry critical for battery management and onboard power management, but does supplement the personal safety features available to the end user and adds the convenience of mixed uses where plug-in power is needed for EV charging and use with other appliances but the installation of dedicated plug outlets is not convenient, timely or economically appealing.

In addition to rechargeable batteries, EVs typically come with power management circuitry. The vehicle may include for example an AC converter termed an on-board charging module (OBCM), which comprises a step-up transformer and rectifier engineered to recharge the battery at a selectably controllable rate that can be optimized for battery life or for “fast charging”. The OBCM will also include means for coordinating the charging conditions with a charging station, and this can be a modulated signal passed through the charging cord or a radio signal, for example. A proximity switch may be included so that the plug outlet 612 is dead unless there is a compatible vehicle 606 within radio or electromagnetic proximity. The OBCM “pilot signal” will select and limit the charging curve based on the available power, and may adjust current per unit time based on a manufacturer's design. The breaker/plug 600 may include circuitry for coordinating and simplifying the charging process when deployed with a compatible vehicle and any supporting software.

FIG. 6C is a block diagram illustrating a 240 VAC breaker/plug device 600a schematically, with digital fault detection and a common breaker that can cut power to plug receptacle 632. The device is useful for EV charging as described in FIG. 6B. While technically not a charging station, the breaker/plug device can be connected to an EV battery-operated vehicle to function as a charging station. The device includes three fault sensing chips or sub-circuits, which, for illustration, may be an overload fault sensor 636, a thermal overload sensor 637, and a ground fault sensor 638. Arc fault sensing may also be provided. The sensing subcircuits report to a microprocessor 630 that includes a comparator and optionally a DSP for detecting fault signals. The microprocessor may include firmware for conducting automated self-testing of one or more of the sensing sub-circuits. The microprocessor may also disconnect power to the plug when an open circuit is detected in the hot lines, and automatically reset when the hot lines are connected to a load, for example when plug 612a is inserted into the vehicle charging port 612. The microprocessor may also detect an open ground condition and disconnect power to the downstream plug and cord until corrected. In selected embodiments, these features are provided as part of a comprehensive personal protection package that leads the industry.

While not shown here, the device 600 may also include circuitry or wiring to receive and demodulate or otherwise detect a data or command signal from the vehicle electronics. In some commercially available vehicles, there is a control pilot unit that uses 1 kHz pulse width modulation used for charging control and communications with a user interface in the charging station. Because much of this can be done efficiently using radio, we have focused on a Bluetooth radio linkage between the breaker/plug device and the user, with the vehicle also in the loop. For example, in some embodiments, the charging breaker 600 will not go live unless there is a compatible vehicle in radio proximity. Radio features are discussed in more detail with respect to FIGS. 25 and 28.

In the embodiment of FIG. 6C, the sensing subcircuits 636,637,638 operate as inputs to the microprocessor 630 and an output from the microprocessor controls a common interrupt 640. Any fault detected as an input results in disconnection of the two hot lines and plug 502 at the breaker. The GFCI function 638 includes a sensing coil 638a connected to a CT around the hot lines 632,633. This circuit is operated as a floating neutral, but includes a neutral line connection to the GFCI chip 638 as is used for the CT sensing coil technology and a self-test sub-circuit 639 that is operated in conjunction with microprocessor 630.

Power to the device is drawn from AC line feed, which is rectified and converted to DC power for the digital microelectronics by power supply 642. The AC feed includes two hot lines HOT1,HOT2 (632,633), a neutral 634, and a chassis ground 635. A battery or supercapacitor (not shown) may be included to ensure the breaker circuitry is operable during transient line interruptions. Radio communication functions and user interface, while not drawn in FIG. 6C, may also be incorporated, as is described below in more detail with reference to FIG. 26. EV charging status is communicated to a cloud host, or reports are made directly to the vehicle owner. Watchdog circuitry 649 may also be provided and may work in concert with a remote or local user interface or may act directly to interrupt a circuit if a component failure is detected, for example.

FIG. 6D describes an exemplary method 650 of charging a battery powered electric vehicle. The method of EV charging by use of a breaker/plug combination is distinct from what is done where a dedicated wall-mounted or station-mounted charger is available. Breaker/plug devices include the devices 100, 130, 140, 150, 160, 310, 320, 400, 420, 500, 600, 700, 720, 1301a, and 1500 illustrated here (optionally including features of devices 2600, 2801 and 3010) that are adapted for 240 VAC or 3-phase wired systems. In a preferred embodiment, the selected breaker/plug devices are 240 VAC units, with typically 30 A or 50 A capacity, are satisfactory as Class 2 chargers when used in the method. In a first step 652, the end user must install the breaker/plug device in the home load panel, generally by removing the dead cover, fitting the modular breaker body onto the hot bus bar, and making a wired connection at least to the ground lug of the load panel, and also in some instances to the neutral bus 654. The top surface of the device with operating controls and status indicators, is visible for testing 656. By powering the load panel and initializing breaker device (such as with a RESET switch), the user can determine visually whether the device is correctly installed. The dead cover is replaced when all circuits are nominal. Once correctly wired, the user optionally can elect to pair any radio-capable breaker/plug devices with a smartphone so as to initiate and program any automated self-testing and reporting features included in software associated with the device. This may include an API for collaborative Internet access with the electric vehicle manufacturer's online support services, for example. In a next step 658, the user will connect a plug to the plug receptacle of the breaker/plug device and connect the distal end of the plug cord to the EV in need of power. The user may verify that the charging process is being correctly reported on the smartphone or other network hub by comparing readings provided in the vehicle or by observing status indicators displayed on the surface of the breaker/plug device. On completion of the charging process, the user can detach the power cord at the load panel plug and stow the cord for future use 660. Various plug ends can be provided as adaptors for use with different vehicles. The user also has the option of keeping a spare breaker/plug device 600 in the vehicle in the event that the only available option for recharging a vehicle is to install the spare in a load panel where the vehicle is parked away from home, for example.

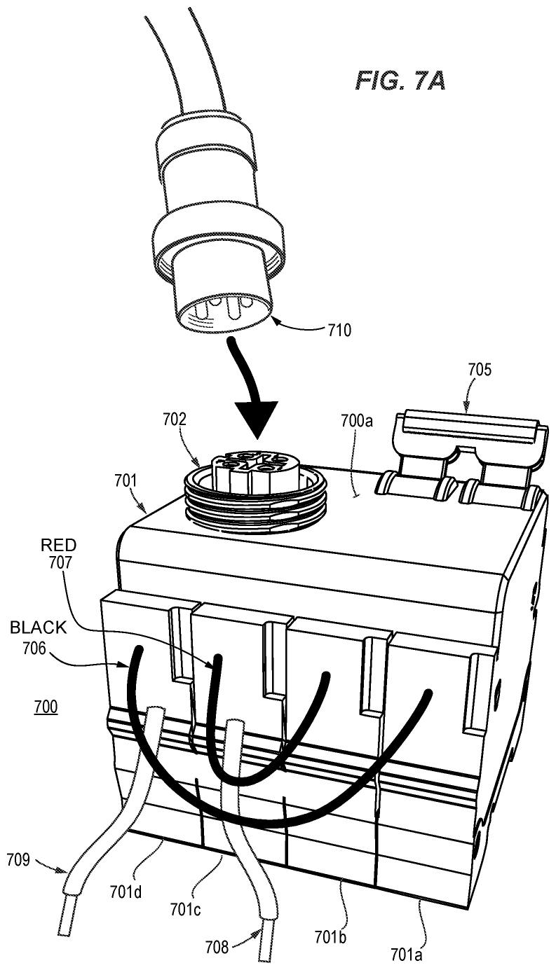

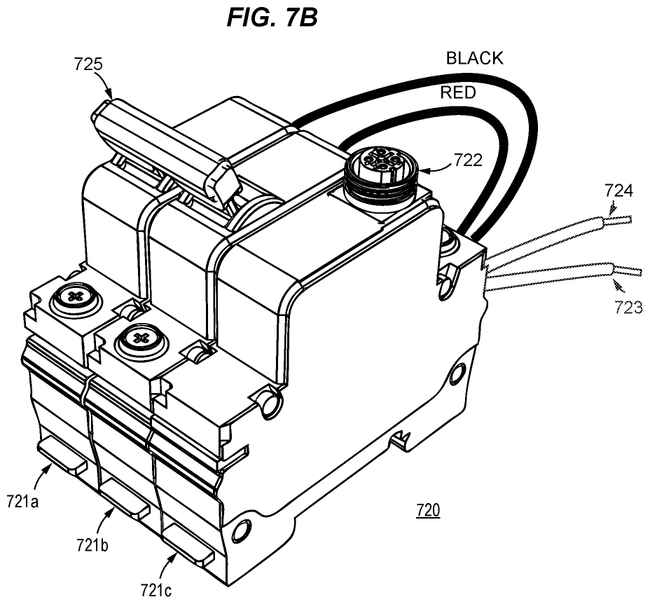

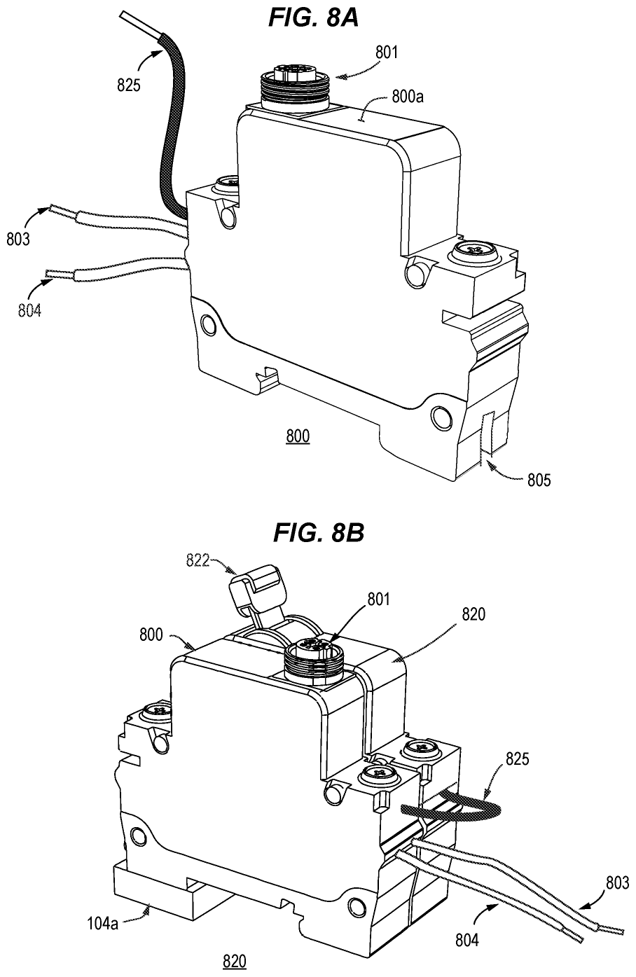

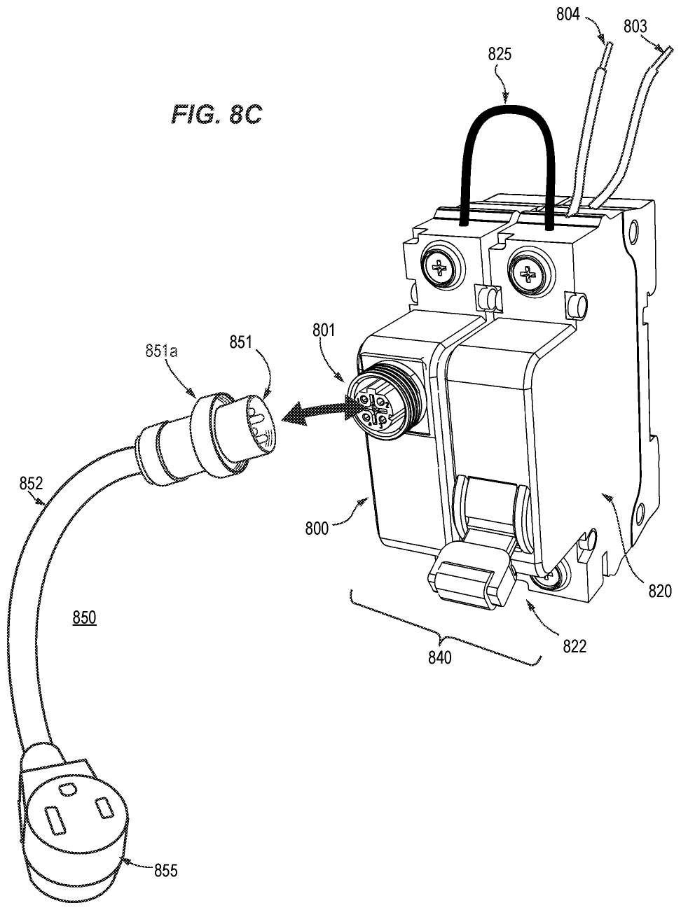

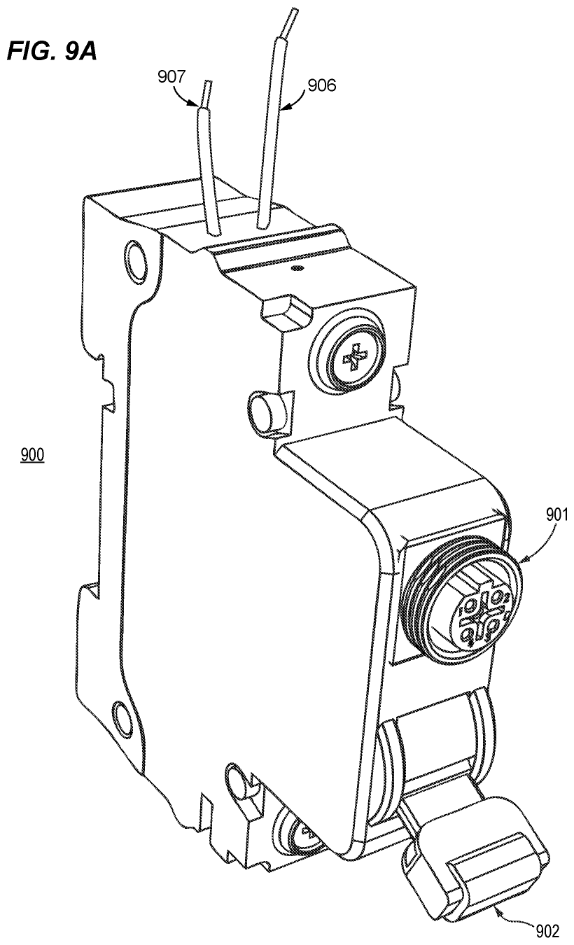

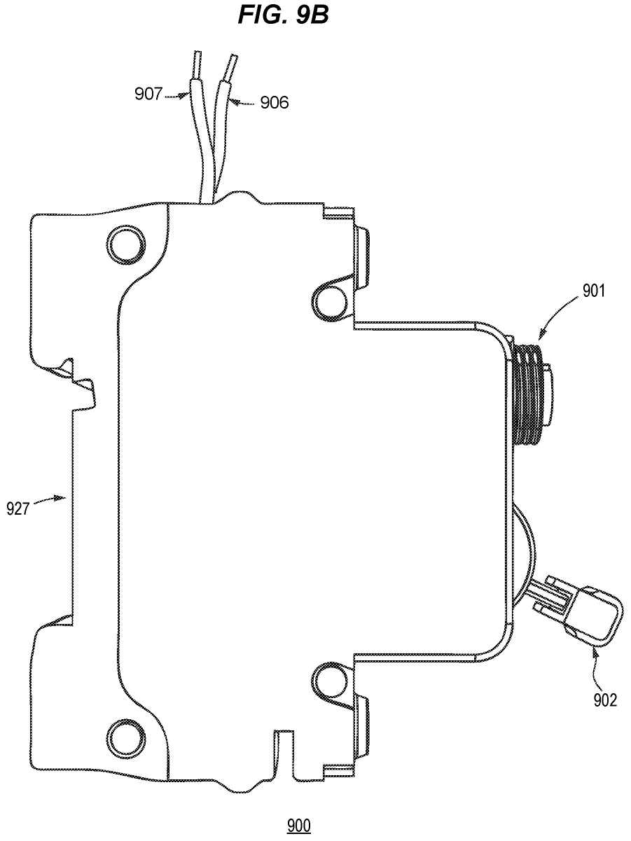

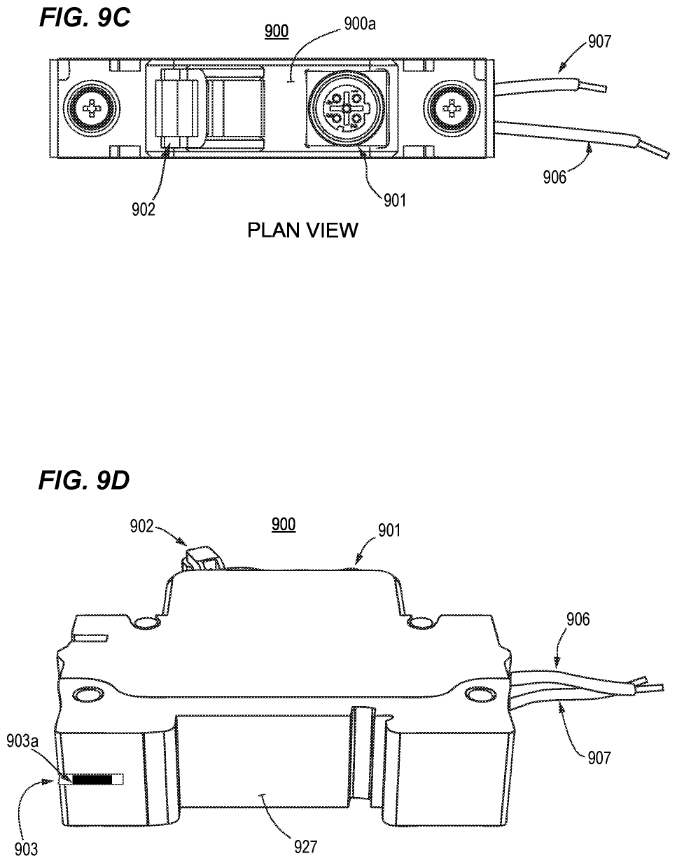

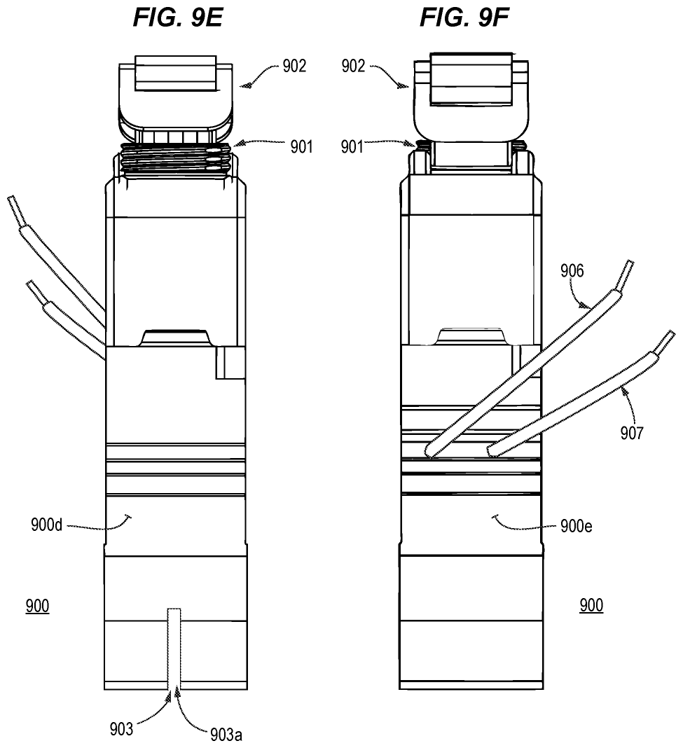

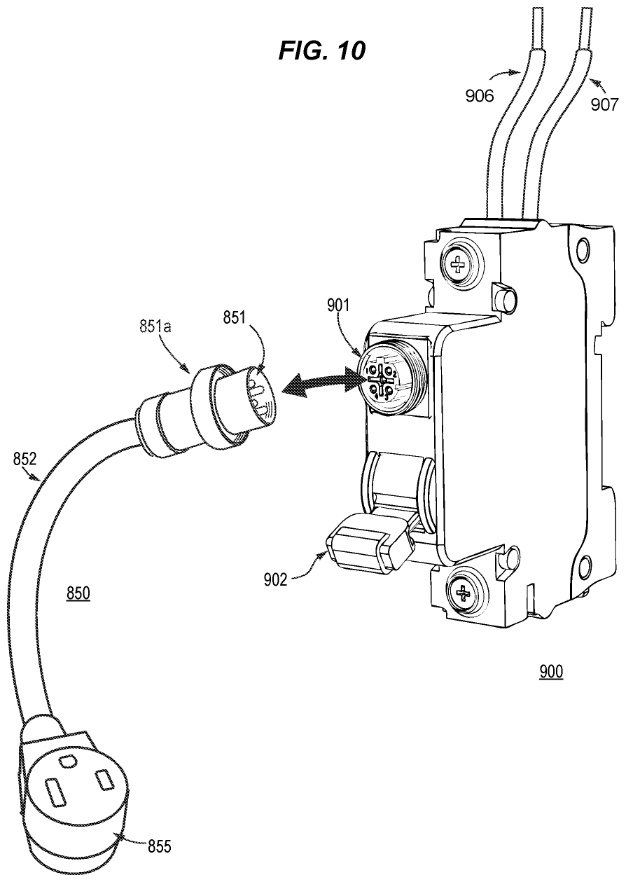

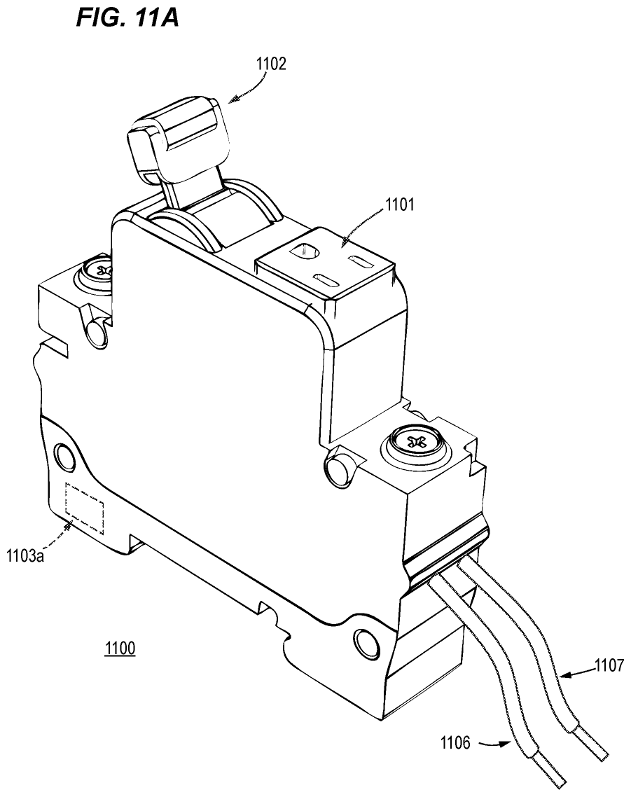

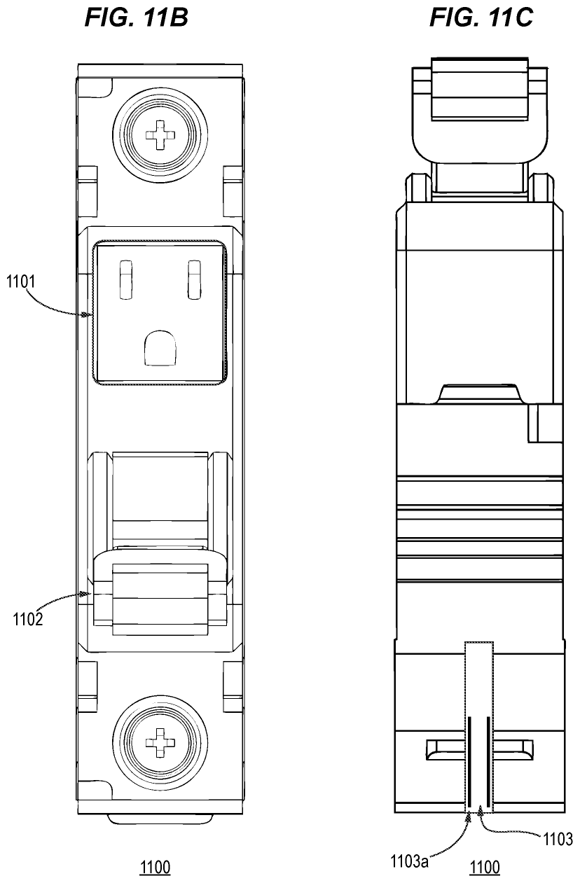

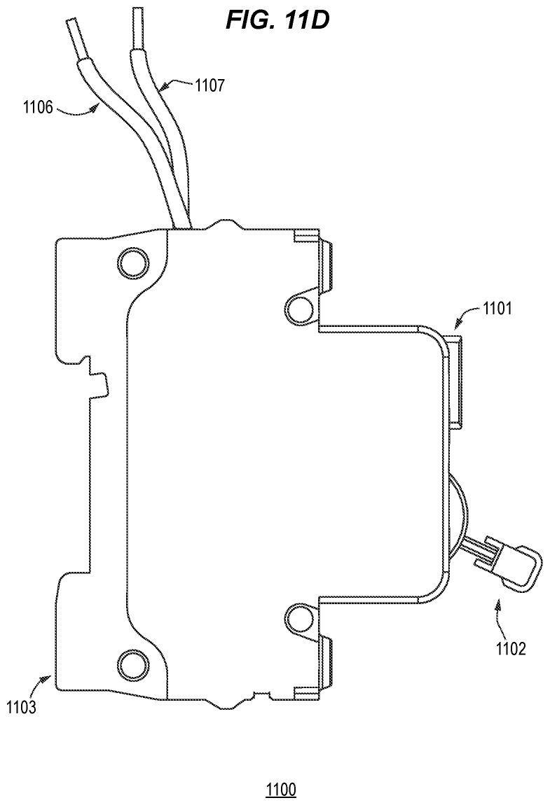

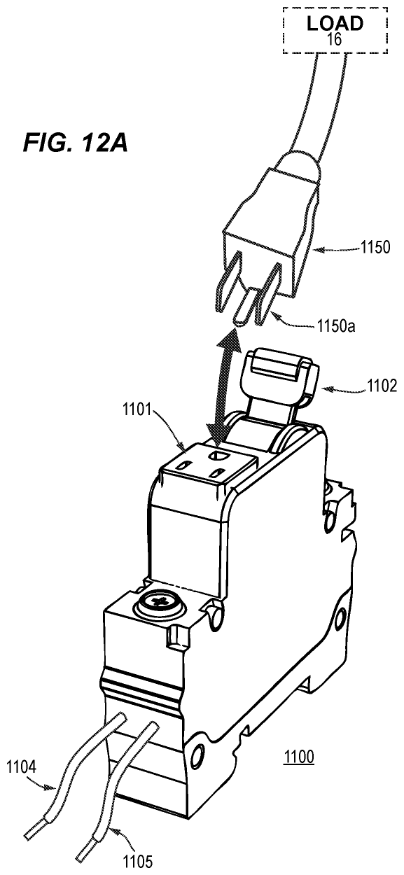

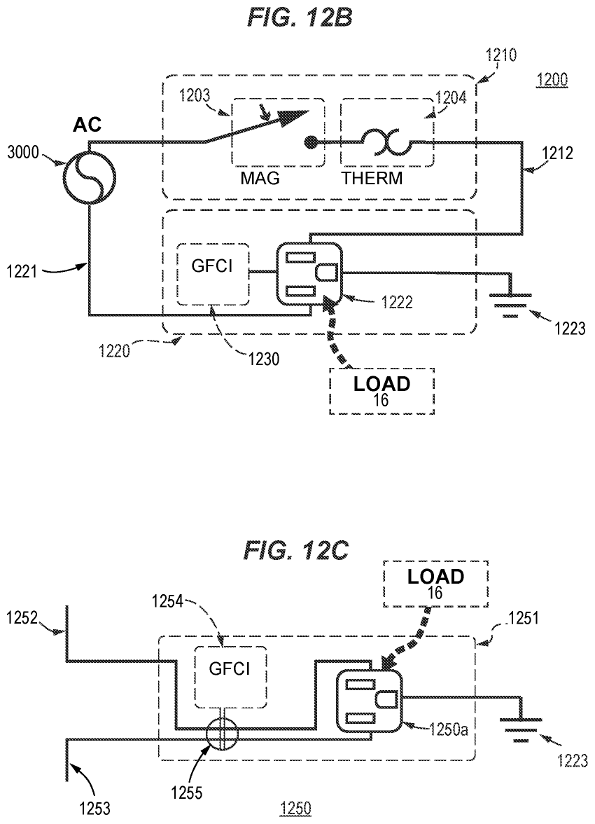

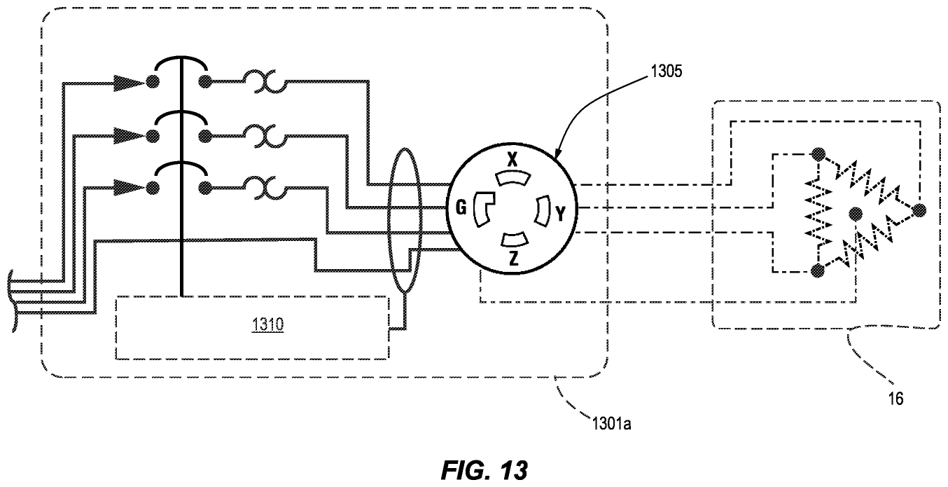

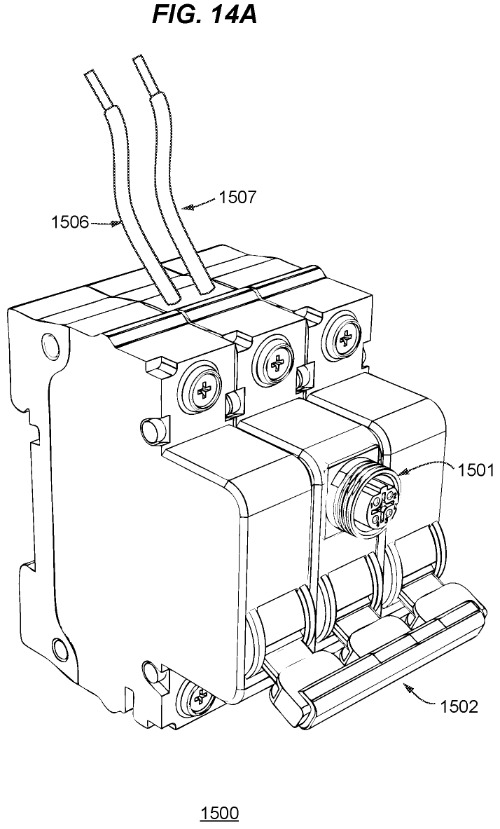

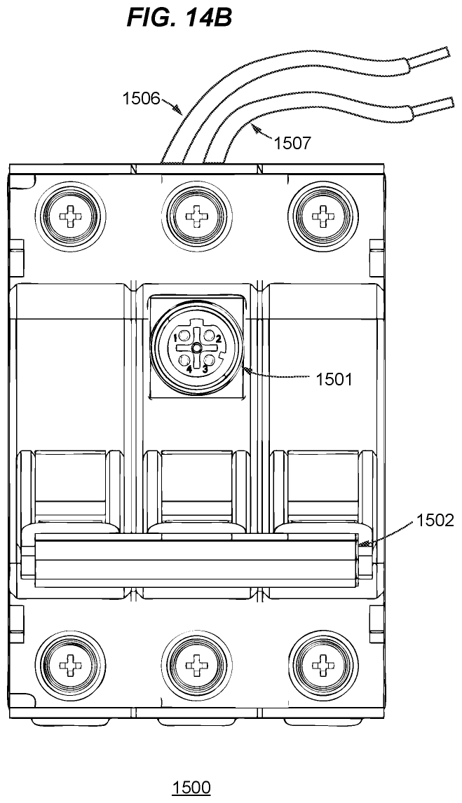

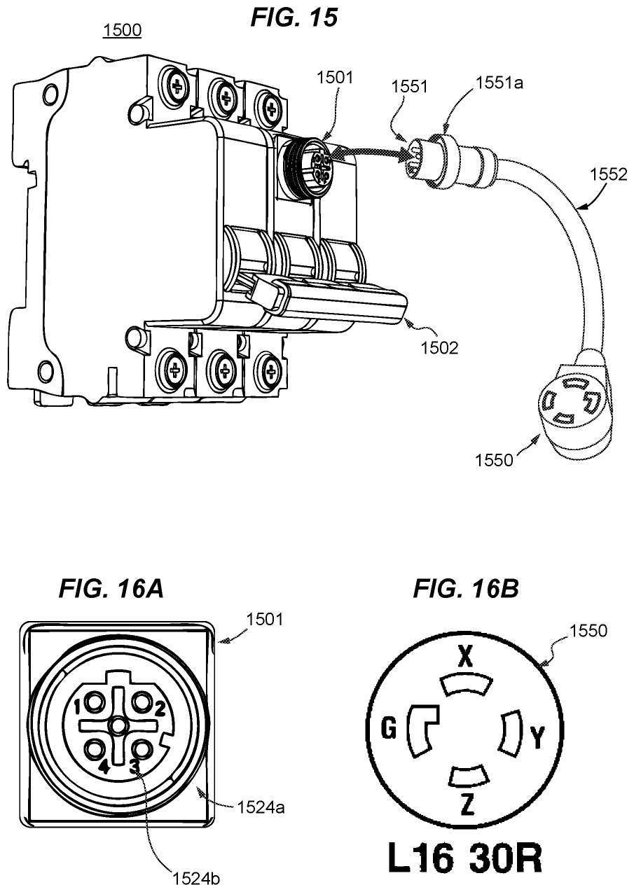

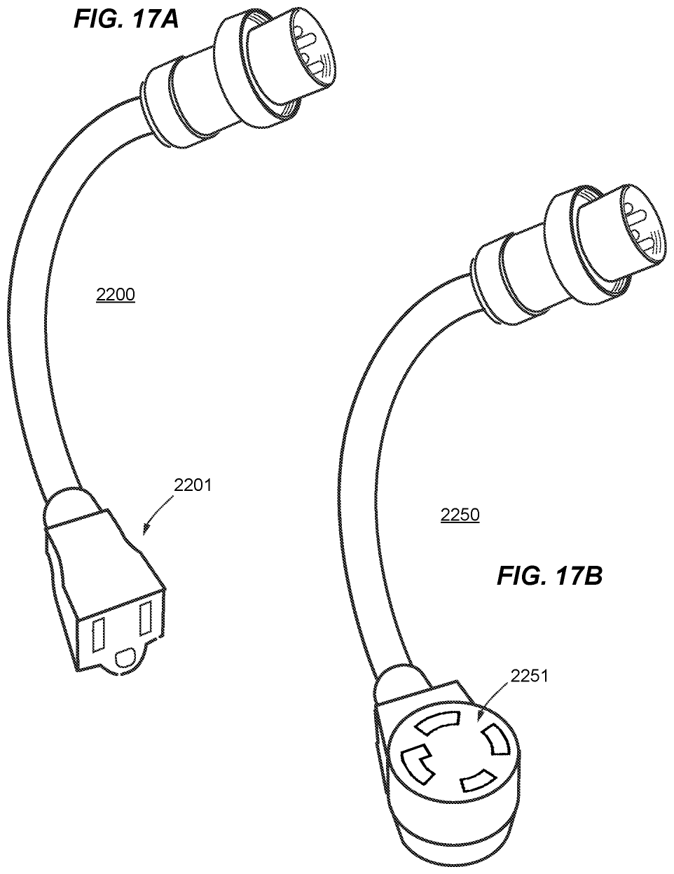

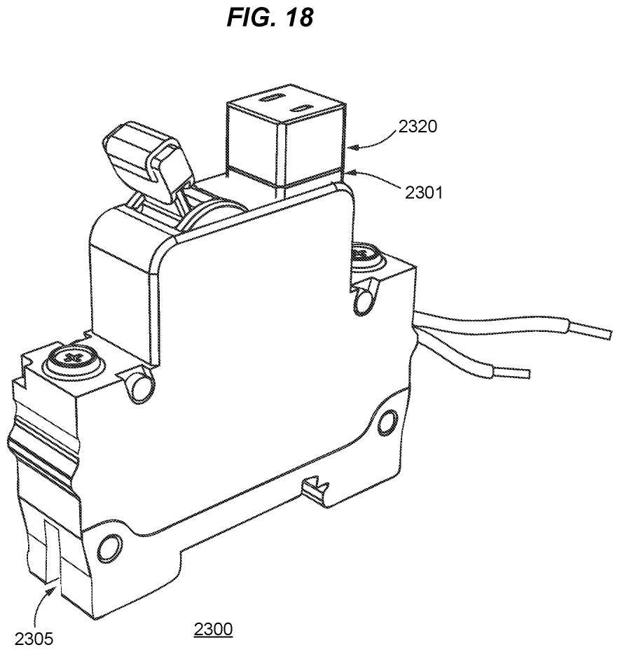

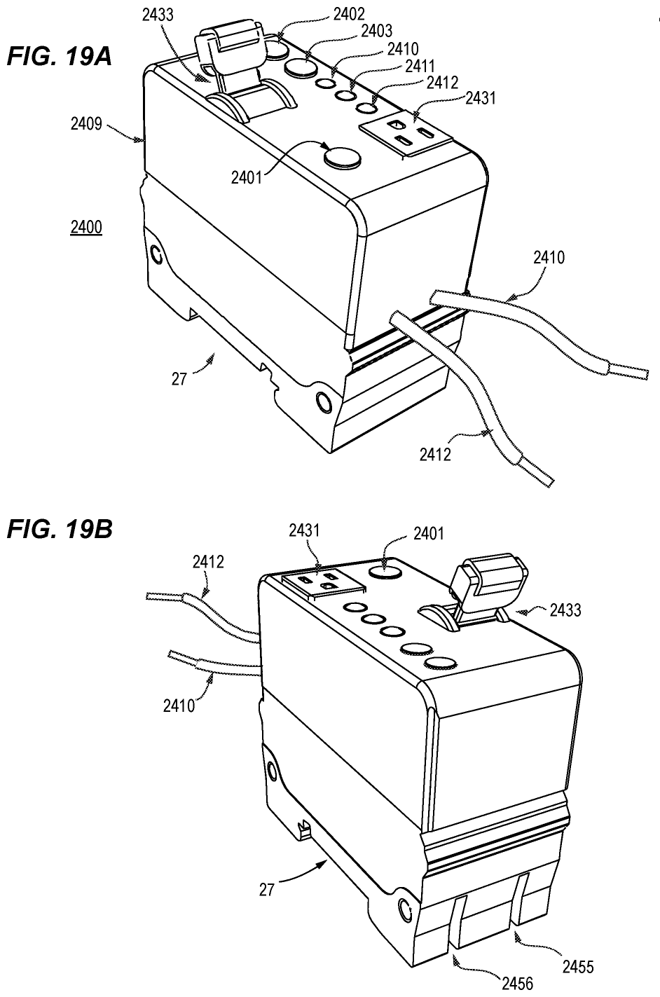

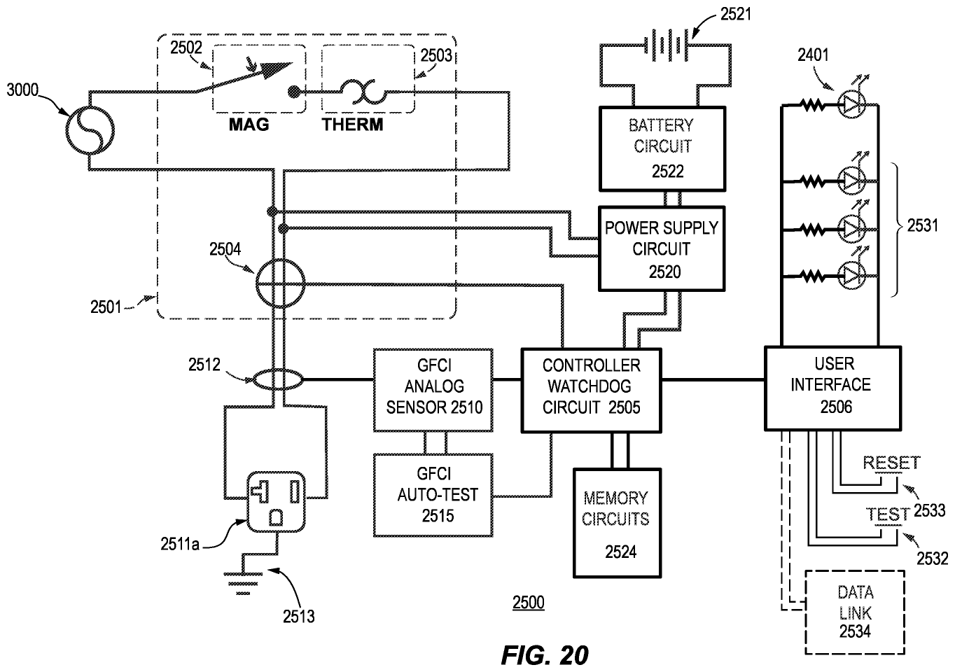

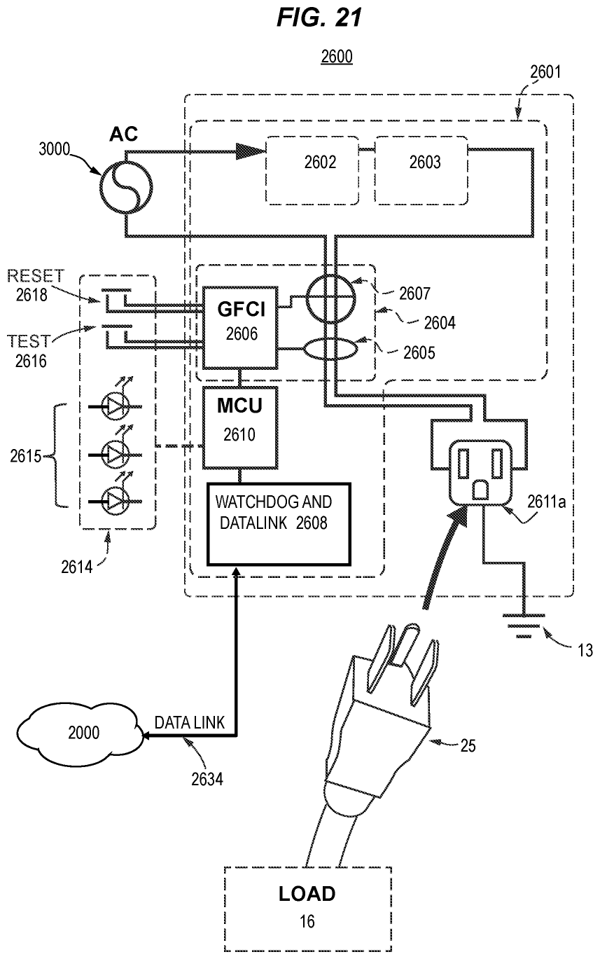

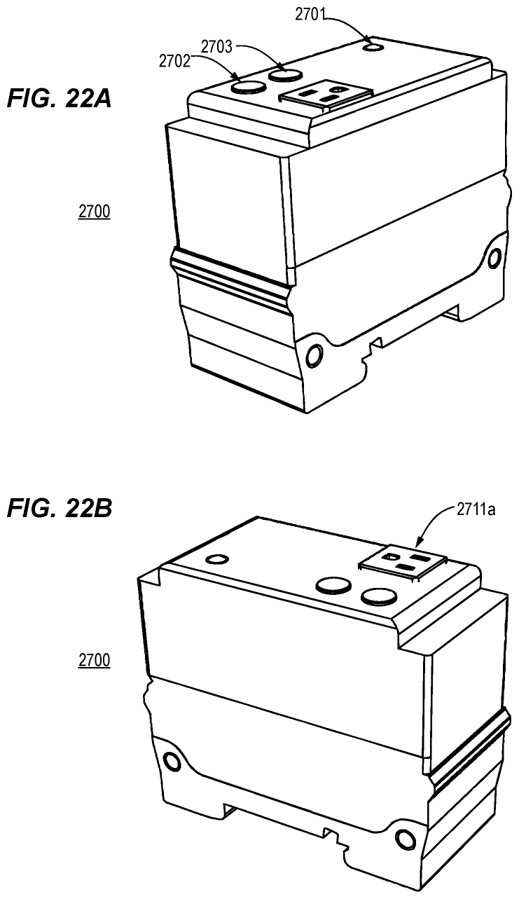

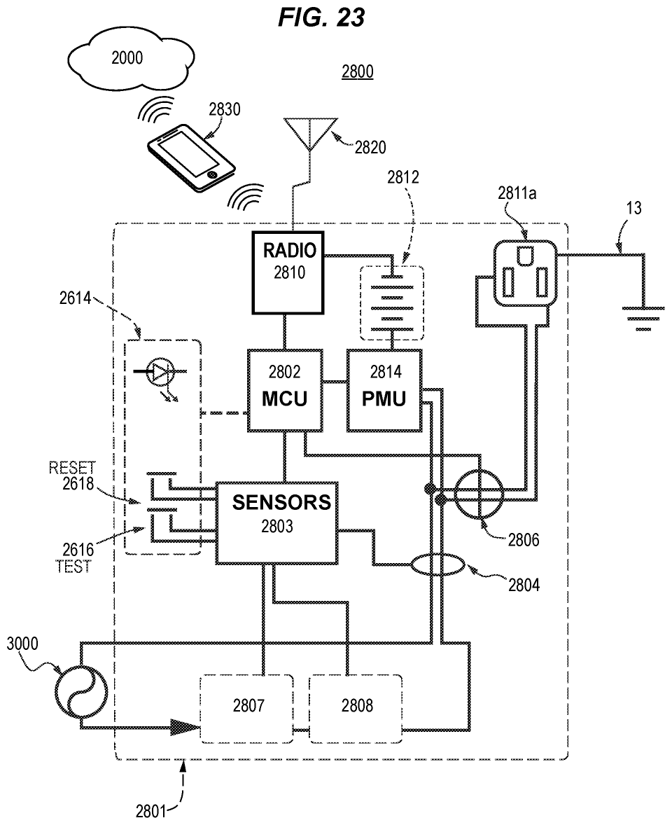

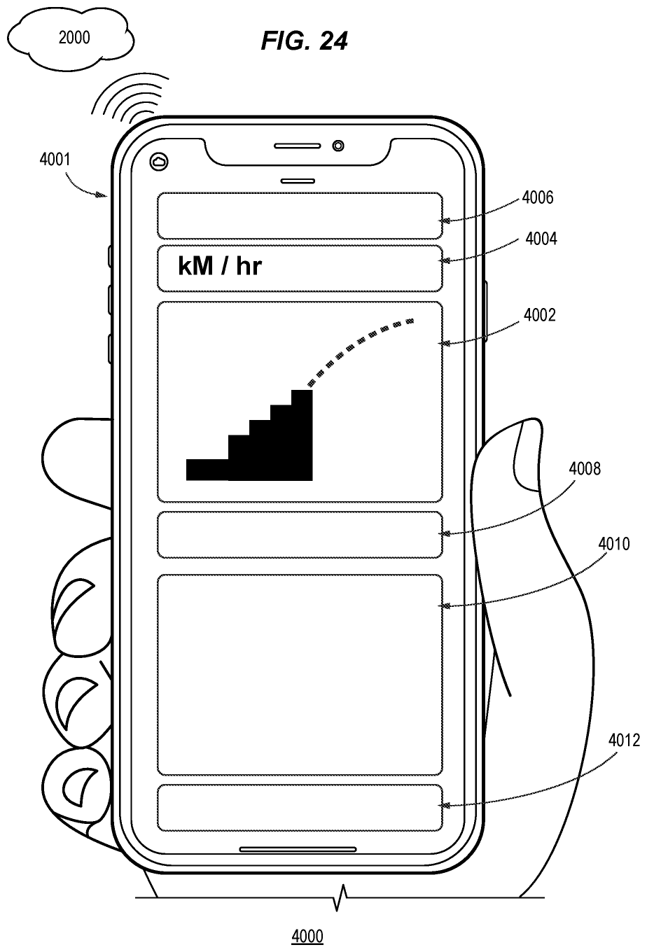

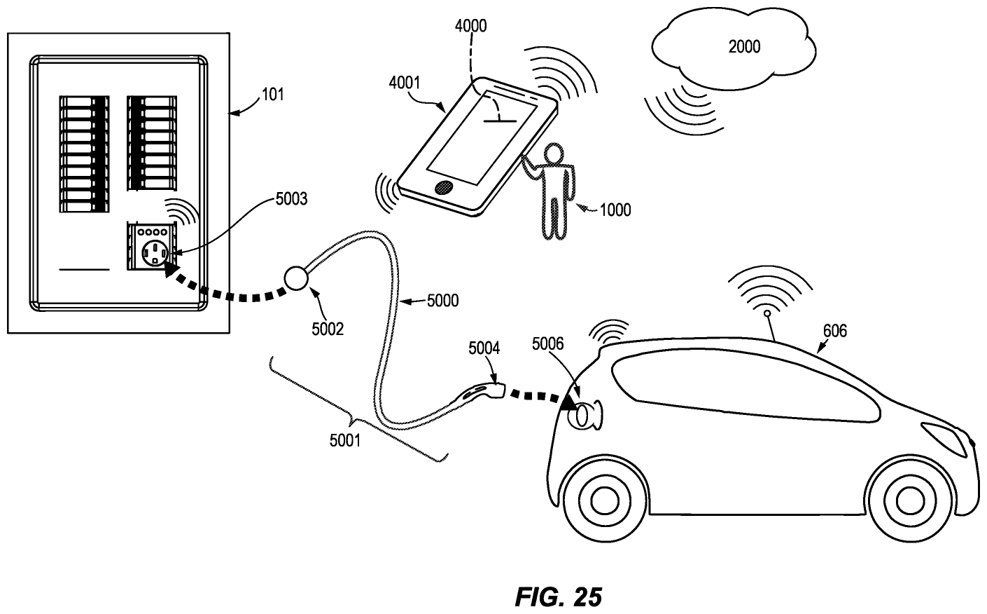

FIG. 7A is a view of an alternate 240 VAC breaker/plug device 700 having a modular body construction 701 that includes two conventional breaker units with double-pole throw switch 705 and a lateral body extension built stackwise of breaker body units (701a,701b,701c,701d) and dimensioned to be installed over two more slots on the hot bus bar (a total of four slots). The extension provides a top surface 700a having dimensions for mounting the female receptacle of a four-pronged aviation plug 702 onto the breaker/plug device.

In this view, the body structure is a composite of four conventional molded circuit breaker units (701a,701b,701c,701d). An alternative option would be to design a single body unit, but given the historical effort, including engineering and safety testing, by which conventional circuit breakers have been developed and marketed, the body structure 701 shown here uses the two standard circuit breaker units essentially in their existing “off-the-shelf” form and adds a lateral extension (units 701c,701d) that contains the plug receptacle 702 and wiring. The lateral extension preserves the required modularity to be compatible with the standard load panel for which the breakers have been designed, while avoiding the posterior extension of the breaker body in marketed conventional products that complicates wiring to the neutral bus bar and ground. The form factor of the lateral extension is what can be termed a “dummy breaker”. To realize this concept, the elements of the dummy breaker body are wired in series with the true circuit breaker units (701a,701b), thus the looped wires labelled “RED” (707) and “BLACK” (706) on the back face of the unit. Also shown are a NEUTRAL and GROUND wire 708,709 as are standard in four wire 240 VAC breakers, but with the added convenience of a plug receptacle that is protected in series by the circuit breakers. The neutral wire may be unnecessary for some applications. Each of the four breaker body units includes a keyway slot compatible with the raised blades of the hot bus bar, but two of the units have dummy slots with no electrical connection and two are fitted with conductive shoes so as to create electrical contacts for supplying power to the plug receptacle. The dummy breaker body elements 709c,709d each include a dummy slot that does not have a hot shoe and seats on the hot bus bar but does not electrically connect to the hot bus bar.

Plug 710 is an aviation-style plug with electric cord and retaining ring that can improve the environmental seal and mechanical strength of the connection. The aviation plug receptacle 705 is circular and is threaded to receive male plug 710 with threaded outer sleeve and 4-pin prongs, for example.

FIG. 7B is a view of a 240 VAC breaker/plug assembly 720 with two circuit breakers and double throw pole 725 and series wiring to an aviation-type plug receptacle 722. Wiring for a dedicated ground 723 is also provided. Neutral wire 724 is optional, but may be used for residual current. Each of the three breaker/plug body modules 721a,721b,721c are configured with slots to insert onto hot tabs of the hot bus bar, with the exception that the dummy plug body 721c includes a slot that is not directly wired, but instead is in series with the circuit breaker elements 721a,721b, and is hot-wired via the BLACK and RED leads shown here to the double pole throw switch 725. This ensures that the circuit breaker elements function exactly as conventional circuit breaker elements. The combination device occupies three slots on a load panel.

The breaker/plug devices may be used for a variety of appliances, not merely EVs, and other adaptations may be made to improve safety and convenience of use. A broad variety of applications are found in a range of 120 VAC uses. Taken together, FIGS. 8A and 8B show a dummy breaker body 800 with aviation plug receptacle 801 that may be wired in series with a genuine circuit breaker. FIG. 8A is a detail view of a dummy breaker device 800 with aviation plug receptacle 801 on the upper surface 800a fitted for series wiring to a circuit breaker. The dummy breaker unit need not include a conventional circuit breaker, but optionally may include a printed circuit board and enhanced personal protection features. Wire leads include a HOT wire 825, a neutral wire 803 and a ground wire 804. Underside slot 805 is a dummy hot shoe and has no electrical connection.

FIG. 8B shows a dummy aviation plug receptacle 801 in series with a fully functional modular circuit breaker unit 820 that is cis-mounted on an adjoining hot bus bar slot or tab. In one embodiment, the dummy plug unit and the circuit breaker unit are supplied separately.

The two units may be separable and wired in series as a head-to-head pair or as a side-by-side pair shown in FIG. 8B, where the hot lead 825 is electrically connected as a series loop between the two body units and the load. Conventional circuit breaker 820 with breaker switch 822 is used without modification by wiring it in series to the plug receptacle 801 of the adjoining dummy breaker body 800 (as shown, wire 825) instead of to a wire harness directly from a load. In this 120 VAC combination, the plug receptacle 801 is capable of forming a closed circuit when the circuit breaker is closed and a load is connected between the hot outlet and the neutral outlet of the plug receptacle by the insertion of an external electrical plug into the plug receptacle 801.

The plug receptacle 801 is live when the single-pole throw breaker bar 822 of circuit breaker is in the live position, and if the breaker is tripped, the plug receptacle is disabled. The breaker can include a magnetic interrupt to trip if there is a circuit short, a thermal interrupt to prevent overheating, and may optionally include a ground fault interrupt. This could involve extending the body of the breaker over the bus bars but here is achieved more simply. Without modification of the conventional circuit breaker 820, the body of the dummy breaker 800 may also contain circuitry for a GFCI interrupt, an arc fault interrupt, and solid state indicators of functionality, such as an LED or LEDs to show that the plug is live and correctly wired, for example, when the dummy breaker body 800 is a lateral extension or stacked next to the genuine conventional breaker body 820, the combination occupying two slots in the load panel.

As drawn in FIG. 8C, in another 120 VAC embodiment, the dummy breaker and circuit breaker may be supplied as a single unit 840 and pre-wired in series for convenience. Hot wire 825 may be looped as shown in the paired body 840, for example. External leads 803,804 to neutral and ground connections are supplied as part of the dummy breaker and are connected to the load panel. The paired body unit 840 will include two slots, one a dummy slot as part of the dummy breaker body 800, and the other a slot with hot shoe as part of the circuit breaker unit 820. The hot shoe of circuit breaker 820 of combination breaker/plug unit 840 is engaged on a hot blade or tab of hot bus bar 104b as described in reference to FIGS. 1C and 3C. The dummy breaker body unit 800 may include a GFCI interrupt, arc fault interrupt, and solid state indicators of functionality, such as an LED or LEDs (not shown here, see user interface 2506,2531 of FIG. 20 for representative controls and status indicators) to show that the plug is live and correctly wired, for example. While fused or formed at a lateral wall as a single unit 840, the breaker pole switch 822 may be essentially identical to the separate circuit breaker unit 820 shown in FIG. 8B.

Cord adaptors 850 with aviation plugs 851 are featured as safety features (as an option to the twist-lock NEMA plug style). In this instance, the first plug end 851 is joined by a short adaptor cord 852 to a second plug end with female NEMA 5-15P plug 855. Use of short adaptors 850 of this kind is merited by the need to connect a variety of plugs. Care is taken in the keying of the aviation plugs so that incompatible second plug ends (855) may not be inadvertently connected to live power. Each dummy breaker unit 800 or breaker/plug unit 820 may be specified according to the kind of electrical connections it can make. Swapping out different dummy breaker devices 800 allows one genuine circuit breaker to be used to protect a variety of plug connections.

As illustrates another embodiment, FIGS. 9A, 9B, 9C, 9D, 9E and 9F are isometric and perspective views of a circuit breaker/plug body 900 with plug receptacle 901 in a single-width body that is insertable in a single slot of a load panel. In this embodiment, the breaker and plug elements are incorporated as a combination in a single body unit 900 having the modular dimensions of a circuit breaker body. The molded body underside includes a latching toe 927 configured for installation on a rail of a load panel. Wiring is supplied for making neutral 906 and ground 907 connections to the neutral bus bar and ground strap of the load panel. A hot shoe (903a, FIGS. 9D, 9E) is provided in the base of the breaker body for connecting to the hot bus bar. The perspective view of FIG. 9A shows a single throw circuit breaker pole 902 specified for 120 VAC. The circular aviation-type plug receptacle 901 is keyed for use with an adaptor 850 (also shown in FIG. 8C) that can come in various configurations. FIGS. 9B and 9C are elevation and plan views of the combination breaker/plug 900. While not shown in this example, the top face 900a of the breaker/plug combination may include an LED or LEDs that act as indicators of circuit status, for example a fault indicator or a live power indicator, if desired. Optionally, a surface-mounted LED can assist in providing illumination of the plug-receptacle so as to assist when inserting a plug into plug receptacle 901 under poor lighting conditions.

FIG. 9D is an underside perspective view of the combination breaker/plug 900 showing the underside surface 900c of the device body, and illustrates a front-facing slot 903 that contains a hot shoe 903a for making a connection to a hot tab of a hot bus bar of the load panel. Current flows from the hot shoe 903a, through the breaker with single-throw pole 902, and to the plug receptacle 901 (FIGS. 9C, 9B), such that when a load is connected, an exemplary circuit is completed through the external neutral lead 906 to neutral bus bar 5a or 5b of the load panel 101. The units may be GFCI-certified if desired. The switch pole 902 may be tripped manually to cut power to the plug receptacle, or may be tripped automatically if there is a circuit overload or fault.

FIGS. 9E and 9F are front and back end views of the combination breaker/plug 900 with plug receptacle 901, single-throw pole 902, and illustrate the hot shoe 903a in a slot 903 on the front 900d of the body and external neutral and ground wires 906,907 on the back end 900e of the body. Unit 900 may be supplied with ground fault interrupt (GFCI) if desired. While provision of a ground lead 907 is not required for operation of a GFCI interrupt, the ground lead serves to direct chassis ground current leakage through the plug receptacle and to a bonded ground strap in the load panel 101. A ground fault may create a differential (or “residual”) current difference between the hot conductor at 903a and the neutral conductor 906 or between the neutral and ground. Under normal operating conditions, the current flowing in the hot conductor should equal the current in the neutral conductor. Accordingly, GFCIs are typically configured to compare the current in the hot conductor to the return current in the neutral conductor by sensing the differential current between the two conductors. At any instant that the differential current exceeds a predetermined threshold, usually about 6 mA, the GFCI responds in a few milliseconds by interrupting the circuit. Circuit interruption is typically effected by opening a set of contacts disposed between the source of power and the load. The GFCI may also respond by actuating an alarm of some kind.

FIG. 10 shows circuit breaker/plug combination body 900 in a context of use; here with an adaptor cord 850 that adapts a 4-pin male aviation plug 851 with cord 852 and locking ring 851a to a female NEMA 5-15 receptacle 855. The breaker/plug combination includes a single-throw switch 902 that is tripped if there is a circuit overload or fault. The body 900 includes a hot shoe that seats on a hot tab of a hot bus bar and two external wires, one lead 906 to the neutral bus bar and one lead 907 to ground. The plug receptacle 901 is fully grounded.

FIGS. 11A, 11B, 11C, and 11D are isometric and perspective views of a circuit breaker/plug body 1100 with 120 VAC NEMA 15-5 plug receptacle 1101 and single throw pole 1102. This embodiment is analogous to that of FIG. 9A, but incorporates the NEMA-type plug receptacle. The body may be configured to support a GFCI receptacle standard if desired. Two external wires are supplied 1106,1107, one to the neutral bus bar and one to ground. The hot shoe 1103a (in slot 1103) that seats on the hot bus bar is connected internally to the plug receptacle 1101. FIGS. 11B and 11C show plan and end views respectively. FIG. 11D is a side elevation view showing the external wires for neutral 1106 and ground 1107 connections.

FIG. 12A illustrates the combination circuit breaker/plug body 1100 in a context of use; here with a standard NEMA-Type plug 1150 with bayonet prongs 1150a and cord that inserts into the female NEMA 5-15 receptacle 1101 on the combination body. For reference, the cord is connectable (bold arrow) to a load 16. The combination circuit breaker/plug body 1100 enables use of a live load panel for temporary attachments of tools, for example, while not limited thereto, without the need to have a wall-mounted hard-wired receptacle within reach of the tool cord. The rigid plug 1150, when mounted in plug receptacle 1101, does not interfere with operation of the single-throw switch 1102. As installed, when not in use, the combination circuit breaker/plug body 1100 does not interfere with closure of the load panel front panel door. The single slot-width device includes wiring for GND 1104 and NEUTRAL 1105 connections to the load panel.

FIGS. 12B and 12C are wiring schematics of devices 1200 for use with NEMA 5-15 plug receptacles. Referring to FIG. 12B, the circuit breaker body 1210 is a genuine, fully functional circuit breaker with internal hot shoe for engaging a hot tab of the hot bus bar on an underside toe of the circuit breaker body. The breaker includes an overload interrupt 1203 and a thermal interrupt 1204. Provision is made for wiring a hot lead 1212 to the dummy breaker body 1220 with plug receptacle circuit 1222 by which hot AC current is fed to a load. The return from the load over neutral wire 1221 is received by the neutral (common) bus bar of the load panel 101. The source AC 3000 is typically supplied from a street utility hookup or from a generator. The plug receptacle is grounded at 1223 to a ground strap of the load panel. Optionally the dummy breaker body can include microelectronics 1230 on a printed circuit panel for displaying circuit status and interrupts for ground fault and arc fault conditions for example.

In the embodiment shown in FIG. 12C, the dummy breaker device 1250 may include a ground fault circuit interrupt (1254, GFCI) in a modular body 1251. As in FIG. 12B, this device 1250 is intended to be operated in series with a conventional modular circuit breaker body 1200 (which contains a trippable short and thermal fault breaker). The GFCI circuit in device 1250 is powered in parallel with the plug receptacle 1250a, and inductively compares current in the hot 1252 and neutral 1221 wires when in use and the circuit is completed by plugging in an appliance or tool to receptacle. The GFCI 1254 trips an electromechanical breaker 1255 (using a solenoid) in the dummy breaker body 1251 if the neutral current return is less than the hot current by 6 mA or more (see UL Standard 943: Standard for Ground Fault Interruptors). Any ground fault creates a differential current between the hot conductor 1252 and the neutral conductor 1253. Under normal operating conditions, the current flowing in the hot conductor should equal the current in the neutral conductor. Accordingly, GFCIs may be configured to compare the current in the hot conductor to the return current in the neutral conductor by sensing the differential current between the two conductors. At any instant that the differential current exceeds a predetermined threshold, usually about 6 mA, the GFCI responds by interrupting the circuit. Circuit interruption is typically effected by opening a set of contacts 1255 disposed between the source of power and the load. The GFCI may also respond by actuating an alarm of some kind. Other kinds of GFCI devices are available.

The dummy breaker device 1250 includes wire leads that extend from the modular body and are for connecting the hot side of the plug receptacle to a neutral terminal of circuit breaker 1200 and for connecting the neutral side of the plug receptacle directly to the neutral bus bar 109 (as illustrated in FIG. 1B). A separate lead 1223 for grounding the plug receptacle directly to the load panel is also provided. The superior surface of device 1250 may include a reset switch and a test switch operably connected to the GFCI circuit (not shown), and one or more indicator lamps configured to display a status of the circuit when, and before, a plug is inserted in the plug receptacle. The underside surface of the dummy breaker body may be configured to be mounted on a hot bus rail inside the load panel, for example, but includes a dummy slot that makes no electrical connection. As a result, the plug is in series through the hot feed from the true breaker via a wire connected to the neutral side of the breaker and the current returns to the neutral bus bar of the load panel via a wire 1253 connected to the neutral side of the dummy breaker 1250 after passing through the sensor coil of the GFCI mechanism 1254.

Body units 1210,1220 and 1251 have a common modular form factor and are compatible with the slots of a conventional load panel and with the hot, neutral and ground connectors of the load panel. The two body units (the circuit breaker 1210 and either of modular dummy device 1220 or 1250) can be placed cis- or trans- on the bus bars (i.e., crosswise on the bus bars or stacked side-by-side). Generally the ground connection 1223 is made directly from the plug receptacle 1222,1250a to the ground strap of the load panel and is a chassis ground.

The two body units are wired separately and may sit side-by-side within the load panel. If side-by-side, the “single-wide” bodies (each modular unit width defining a standard width of a “slot”) may be contacted at an opposing lateral wall and are wired as a “double-wide” pair of modular units in the load panel such that a lateral wall of the circuit breaker rests beside a lateral wall of the dummy breaker body. Advantageously, the dummy breaker body can include an internal GFCI circuit interrupt so that the combination of circuit breaker plus plug receptacle in series has overload, thermal and ground fault interrupt breaker functions without increasing the electromechanical complexity or cost of the standard breaker unit.

Alternatively, the two body units may be wired in a trans-position in which the body units sit head-to-head in the load panel, the hot wire from the circuit breaker extends across to the dummy breaker plug body, and the neutral or common wire runs from the dummy breaker plug body to the neutral or common bus bar and is grounded to a ground strap or bus within the load panel. In some embodiments, the two units, conventional breaker and dummy breaker body with enhanced features, are supplied as a single unit that occupies two “slots” or three slots on the bus bar. Generally a pigtail is supplied so that the plug receptacle can be connected in series with the neutral bus bar, and another wire is supplied for routing a chassis ground (traditionally a green wire) to earth ground in the main breaker box.

FIG. 13 is a schematic of a circuit breaker/plug receptacle combination 1301a configured for 3-phase applications. The circuit includes a fault detection subcircuit 1310 directly tied to a circuit interrupt that will disconnect all three hot phases if a fault is detected. The breaker plug assembly 1301a, shown here schematically, is wired with a neutral return line that includes a ground. As shown here, the plug receptacle is a NEMA L21-30P receptacle 1305. Three-phase power has the advantage of supplying greater torque to motors, for example and a “Wye” load is shown here. This device is configured to be mounted directly within a load panel with exposed plug surface.

GFCI faults in three-phase circuits can be monitored in suitably configured breakers by use of a current transformers (CT) or “sense coils” using several methods. Residually connected ground relays are sometimes used with three-phase devices in which current returns by a Wye neutral from a motor winding, for example. Direct sensing of any core imbalance in the feeder conductors by a single CT is another use in which a ground relay carries the fault signal and relays it to a switch that opens the circuit. Alternatively, by calculating any algebraic phasor imbalances between each of the hot conductors and the output of a lower ratio CT in the neutral connection to earth ground, for example, a ground differential relay can be opened in the event of fault. Silicon controlled rectifiers (SRC) functioning as relays have significantly improved the circuitry.

In another embodiment, the combination circuit breaker/plug body includes a single NEMA L16-30R for receiving a mating NEMA L16-30P plug (not shown). The device is suitable for temporary use and may be removably clipped into a load panel by a homeowner or tradesman without the need to install wall-mounted plug boxes on the load panel. In some instances the poles of the circuit breaker will be engaged on an existing 240 VAC station in the load panel and will combine a third 120 VAC pole. All the wiring may be powered by a single feed from an offsite mains that supplies power from an electric grid or from a generator, for example. While not bound by theory, the circuit breaker/plug devices may be adapted for multiphase AC configurations at higher voltage drops without departure from the spirit of the inventive concepts.

FIG. 14A is a perspective view of a 3-phase circuit breaker plug assembly 1500 with aviation circular connector 1501 and combined triple-pole throw switch 1502. The assembly includes neutral 1506 and ground leads 1507, as indicated to attach directly to the combination breaker/plug body units, which insert onto the hot bus bar with shoes at the opposite end of the body. FIG. 14B shows the 3-phase combination breaker/plug assembly 1500 in plan view. The body units are contacted at lateral walls and are fitted with a common throw bar. Each breaker engages one of the three-phase hot feeds.

FIG. 15 shows triple-slot circuit breaker/plug combination 1500 with aviation-type circular plug receptacle 1501 in a context of use with a four-pin plug adaptor cord 1552. The device housing is slotted or otherwise toed so as to mount directly and engage the hot bus bar(s) of a load panel. Voltage on each of the hot bus bars is returned on a single neutral or common and is controlled with a single combined three-pole throw switch 1502. Neutral and ground leads are wired to the neutral and ground bus bars of the load panel. In this instance, the receptacle is configured with an aviation circular connector 1501 rather than a NEMA receptacle. The 4-pin circular connector 1501 is configured to receive (as an adaptor) a mating aviation connector 1551 with male pins and a safety threaded sleeve 1551a which can be waterproofed to the IP67 or IP68 standard. A gasket may be used inside the connector and inside surfaces of the throw switches. The adaptor connects an L16-50R plug 1550. A system of keyways may be used to identify compatible plugs and to ensure that pin wiring is correctly mated across the connector.

The plug receptacle 1501 is shown in plan view in FIG. 16A. Aviation circular connector 1501 includes numbered pin receptacles. Pin 4 for example may be a common and pins 1, 2 and 3 may be phases for 3-phase power. The face of the plug receptacle is marked 1524a and pin 3 is marked 1524b for reference.

The opposite end of the adaptor 1552 shown in FIG. 16a is drawn in plan view in FIG. 16B. This is a NEMA L16-30R plug 1550 with ground or common G and phases X, Y, and Z for each of three phases of a 3-phase power supply. The short cord length 1552 may instead be directly wired to an appliance or load in need of electrical power.

In one embodiment, the single receptacle joins three AC phases to a common return. The breaker assembly also may include solid state components for monitoring operation, such as a green LED when the circuit is correctly installed and all phases are operating correctly and a blue LED when the circuit is live. Operating temperature and overload may also be monitored.

FIGS. 17A and 17B are views of two adaptor cords 2200,2250 having each a short cord with two distinct ends. In this representative example, embodiments of various adaptors are shown having each a 4-pin aviation male “reverse” connector on a first end and either a standard NEMA 120 VAC plug 2201 (shown here as a female plug) or a NEMA 240 VAC plug 2251 on a second end. One or more adaptor cords may be supplied with a mating universal circuit breaker plug assembly of the invention as a kit. These short adaptors may be supplied as a set for use with any one of the breaker/plug units disclosed. Each adaptor includes a distal plug head for receiving a power cord from an appliance or load, and a proximal plug end for engaging the plug receptacle inside the load panel box. Alternate adaptors may include alternate plug heads. The adaptors and plug receptacles may include keyways to ensure compatibility. Each breaker/plug unit may be specified according to the kind of electrical connections it can make, or a universal device may be compatible with a variety of downstream plug adaptors. Swapping out different dummy breaker devices allows one circuit breaker 3 to be used to protect a variety of plug connections, for example.

FIG. 18 is a view of a combination circuit breaker/plug device 2300 and a “plug-in” adaptor 2320, shown here as useful to convert a 3-prong plug receptacle 2301 with ground to a simple two-prong receptacle that is commonly used for household 15 Amp appliances and is ungrounded. A variety of plug-in adaptors may be provided. Although this can defeat the protective chassis ground, the “plug-in” adaptor 2320 may be fitted with a ground lug and external wire (not shown, as known in the art) that is recommended to be connected to a ground strap for safe use. While not ideal, many small appliances are not supplied with 3-prong plugs; hence the need for a two-prong adaptor. However, by adding a GFCI breaker to the device 2300, ground fault protection is extended to plug-in appliances having two-pin male plugs and no chassis ground connection.

### Example I: GFCI Combination Device

FIGS. 19A and 19B are perspective views of a modular circuit breaker/plug receptacle combination with user interface. Combination device 2400 having a NEMA-style 120 VAC plug receptacle, a circuit breaker with thermal, overload and ground fault interrupts, and solid state watchdog circuitry that monitors the breaker status. The device may include communications circuitry configured to report the breaker status to a network. The network may include a cloud host that receives reports and archives the results or generates notifications that are sent to a responsible party if there is a non-compliant status. This double wide device facilitates incorporation of the circuit features shown in FIG. 20 or 21, and also permits incorporation of the various plug receptacle styles internationally in use.

Device 2400 is designed to connect on the underside to a hot bus bar and to be connected to a neutral return and a ground strap by external wires 2410,2412. The details are not fixed because some circuit load panels are designed for snap-on neutral connections that eliminate the need for neutral wire 2412. The device includes a plastic body 2409. Molded body devices of this style may also include multiple hot rails for three phase power applications, but in this instance an underside slot 27 for installation on a conventional hot bus bar or rail is shown. The device (FIG. 19B) includes two front bottom slots 2455,2456, one of which includes a live hot shoe for receiving power from a hot bus bar when mounted 27 with latching toe on a rail. For illustration, slot 2456 is described as having a hot shoe that connects the hot feed to the plug receptacle 2431.

GFCI protection is built into the device. Unit 2400 is supplied with ground fault interrupt circuitry coupled to the plug receptacle. While provision of a ground lead 2410 is not strictly required for operation of a GFCI interrupt, the ground lead directs any current leakage through the plug receptacle and to earth ground via a ground strap in the load panel.

A ground fault creates a differential current between the hot conductor 2456 and the neutral conductor 2412. Under normal operating conditions, the current flowing in the hot conductor should equal the current in the neutral conductor. Accordingly, GFCIs are typically configured to sense the differential current between the two conductors. At any instant that the differential current exceeds a predetermined threshold, usually about 6 mA, the GFCI responds by interrupting the circuit. Circuit interruption is typically effected by opening a set of contacts disposed between the source of power and the load, in this case in the breaker body and operatively connected to the plug receptacle 2431. The GFCI or an associated watchdog circuit may also respond by actuating an alarm of some kind in response to a fault. Analogous features may be incorporated to generate alarm conditions for short, thermal overload, and arc fault conditions.

In addition to a conventional plug receptacle 2431 and single throw switch 2433 the uppermost panel of the device may include a user interface that includes a lamp 2401 for illumination of the work area, a reset 2402 and test 2403 switch coupled to the GFCI interrupt, and one or more indicator lamps 2410,2411,2412 that are green when the device is working properly, or otherwise alarm or warn of a fault.

FIG. 20 is a schematic 2500 of a circuit breaker/plug receptacle device with ground fault circuit interrupt, user interface, optional datalink, and battery backup. The circuit includes a magnetic breaker 2502, a thermal breaker 2503, and a ground fault interrupt 2504 with ground fault inductive sensor 2512 and GFCI comparator circuitry 2510 that monitors hot and neutral current through the plug receptacle and trips the circuit interrupt 2504 if the differential current is 6 mA or more, as is the conventional limit for a ground fault interrupt. Ground leakage of less than 4 mA does not trip the breaker. The three circuit interrupts 2501 are operatively coupled to plug receptacle 2511a, which is shown here with an isolated ground strap 2513. The user interface 2506 may include TEST 2532 and RESET 2533 switches.

The ground fault sensor 2510 may be linked to an auto-test circuit 2515. Periodic testing of the GFCI mechanism 2504 is recommended and may be performed automatically on a monthly basis, for example. The GFCI solenoid may be reset after each test or a simulation of a trip condition is run without actually tripping the breaker. With solid state breakers, the inconvenience of manually resetting a solenoid is avoided. The controller/watchdog circuit 2505 includes a microcontroller that may execute instructions from a memory circuit or cache 2524 such as would include firmware, EEPROM, or software-encoded instructions. The controller/watchdog circuit 2505 monitors the circuit interrupts 2501 and alarms if a hazard condition develops, a component fails, or a test of the breaker fails. A history of electrical events and fault flags may be stored locally in memory circuit 2524, such as RAM or flash memory, and may be sent to a central monitoring station, cloud host 2000, or user's smart device 4001 (FIG. 24) via data link 2534, for example. Z-RAM memory may be included to prevent loss of certain kinds of essential data. Any alarm notifications may take the form of a display on the user interface 2506 (such as by providing LEDs 2531 that display device status) or may be sent via a wired or wireless data link 2534 for remote monitoring. Data collection may include response time, sensitivity, tolerance, and cutoff thresholds, for example.

The devices include reset features that can be electromechanical, analog or digital, such as lever arms operated by a servo, stepper motor, or winch, or solid state circuit interrupts (not shown) monitored by a digital watchdog, and FET set or reset switches with microsecond response time, for example.

A power supply circuit 2520 draws power from the AC line feed 3000 to power the logic circuitry. Digital logic circuit power V_{cc} is supplied from a voltage regulator and conditioner downstream from a rectifier. A low dropout (LDO) switching regulator is included in the power supply circuit 2520 to switch the power from AC to battery or from battery to AC as available. For stability of operation and for use in data tracking, a rechargeable battery 2521 and circuit 2522 is included so that clock, alarm, memory, user interface, and data link functions are not interrupted by temporary power failures.

When a load panel is used for grid power flow from local power supplies upstream to the grid or from local power supplies to downstream local loads, the integrity of the system during any interruption of grid AC supply becomes an issue that is solved here by including rechargeable battery 2521 and charging circuit 2520,2522. The battery may be sized according to the energy budget of the entire circuit 2500. The battery circuit 2522 can include battery diagnostics circuits (such as weak output) and battery data reporting capacity. In addition to duty cycle control of power management, power supply circuit 2520 can include definitions for standby conditions that selectively de-power parts of the circuit. For example, the microcontroller can include a low power state in which only the clock is being powered and a wake monitor is set so that the device can wake up according to a clock signal, or some other digital input that awakens one or more higher processing functions of the device. In some instances, such as when there is a BT radio modem or a CELLULAR radio modem in the breaker device, the modem controllers may be selectively powered to function as networked or ad hoc peer-to-peer “wake radios” or “always listening radios” as a specialized low power operating state that enables the device to be operated from battery power for hours, weeks and even months. A proximity detector powered by Bluetooth radio may disarm the breaker unless and until a compatible vehicle is within proximity. Similarly, the device 2500 may sleep during periods when grid or household energy draw is maximal and wake up to commence an EV charging cycle during off-peak hours. Means for switching from grid AC to a photovoltaic AC power supply are options, but to prevent data loss, a small rechargeable NiCad battery, or a 9V battery such as commonly used in smoke detectors, for example, may suffice for extended use during power interruptions.

The batteries 2521 would not typically be large enough to power a downstream load, but may be sufficient to power a radio transmit/receive session for networking during power failures, or a user display of device status even when street power is down. These features may be useful when the device is configured for receiving power via the plug-in cord and for conveying that power to a larger battery that is fed from the load panel, for example, during emergency use. The battery may also be used to provide emergency lighting during power failures, and smart photocell logic (not shown) may be used to control lamp 2401. The lamp 2401 (FIG. 20) illuminates the entire load panel with a soft white light only when needed.

The batteries may also be used to power a speaker (not shown), if the device is configured for function as a cellular radio, (i.e., it has a SIM card, a Cellular modem, and optionally a synthetic radio driver circuit) and may convey voice messages or alarm tones. Addition of a microphone provides the user with a stand-up telephonic service powered at the breaker box with battery reserve backup. In one limited embodiment, the device would provide 911 calling in the event of an electrical injury condition such as a sudden arc or short in the plug receptacle when combined with input to the watchdog circuit of motion sensor data from a sensor mounted on the front panel of the device (not shown) or microphonic inputs from a microphone, as may be processed by a digital signal processor (DSP), with suitable filtering of the raw output of a microphone, or by the microcontroller following A/D conversion.

The watchdog circuit 2505 may generate event monitoring data, including flagged events and alarm conditions. Alarm conditions may be indicated on the device by LEDs 2531. Data may also include a variety of sensor data, include one or more temperature sensors, pressure sensors, current sensors, voltage sensors, impedance sensors, Hall effect sensors, accelerometers, GPS sensors that are radio operated, and any type of network-assisted AGPS or triangulation of signals for generation of location data such as for tracking of inventory and job locations, and one or more of any other type of sensor, without limitation.

Data link 2534 may be connected to an external reporting station or cloud server, for example. The link can be a wired or wireless link, but generally is configured for serial data transfer. The device may include circuitry for processing packet data received or sent in one or more formats. Bluetooth, WiFi and cellular packet data standards differ, but with 5G are increasingly becoming interlinked by “edge computing” capacity. The devices may include such edge computing capacity in the watchdog 2505 or in an enhanced data link engine 2534 with smart algorithms and access to data locally from smartphones, home hubs, cloud services, or from remote databases. Surprisingly, Bluetooth radio signals are able to readily penetrate the interference created by the AC sine wave and dampening of the breaker box frame and cover. Alternatively, an ethernet cable or other wired UART databus for example may be used to collect data, prepare reports, and make notifications of any fault or failure in the combined device (or in an appliance that is plugged into plug receptacle 2511a). Plug receptacle 2511a as shown here is sometimes referred to as a “T-slot” connector that accepts both a 3-prong 5-15P NEMA mail plug as well as a 5-20P male plug. These are compatible with both 15 and 20 Amp breakers and wiring. Analogous devices having aviation-type plug connectors are also envisaged.

In another application, the clock of the device microcontroller 2505 can be used to perform a control function such as turning on a plug-in device or turning off a plug-in device at switch 2502, for example.

The larger volume of the multi-slot devices 2500, combined with efficiencies of space achieved with solid-state microelectronics, allows the manufacturer to pack more into the device body. A radio is an ideal accessory for a “smart breaker/plug”, and is described in more detail in FIG. 23. While not shown, the larger breaker/plug devices may also include inverter or DC circuitry for transferring power from an outside source to the grid or to a local battery storage unit.

### Example II: GFCI Device with User Interface, Datalink and Cloud Host

FIG. 21 is a schematic 2600 of a circuit breaker/plug receptacle combination device with user interface 2614 and datalink 2634. Three breaker elements 2602, 2603, 2604 are combined in the device to protect the plug receptacle 2611a, and any plug-in appliance or load 16, from a fault condition. Plug 25 inserts into the plug receptacle during use and is grounded 13. The combination device includes a microprocessor or microcontroller (MCU) with user interface and indicator lamps for local reporting of device status. Circuit 2600 is mounted on a printed circuit board (PCB, 2601) and includes an MCU 2610 that functions in receiving local commands from the user interface 2614 and an optional data link 2634 to an external monitoring system 2000, depicted here as a cloud computing resource, while not limited thereto. Digital logic circuit power V_{cc} is drawn from the AC line 3000 feed by a voltage regulator and conditioner downstream from a rectifier generally as described in FIG. 20.

Breaker element 2602 is a current overload breaker; breaker element 2603 is a thermal overload breaker. The breaker circuit(s) include a GFCI unit 2604 operatively linked to the plug receptacle 2611a. The GFCI unit includes an analog differential current detector (with coil, 2605 and solid state analyzer unit 2606), and an electromechanical trip switch 2607.

Associated with the PCB 2601 is a user interface panel 2614 that includes a manual switch 2616 for testing and a reset button 2618. Control signals are generated to the microcontroller when the reset and test buttons are pressed. In one embodiment, test button 2616 causes a simulated ground fault. In another embodiment, test button 2616 may be configured to cause the MCU to simulate a fault condition in each of the three circuit interrupts and to assess overall device readiness. By automating testing functions under control of an MCU clock, a significant level of operator relief is achieved from the burden of recommended monthly testing of the GFCI circuit interrupt. Optionally, the automated testing can also be performed whenever a new appliance 16 is plugged into the receptacle 2611a.

LEDs 2615 serve in displaying device status and may be color coded, for example a bank of green LEDs can indicate proper operation of all the breakers of the device. A flashing LED, or a red light (when using RGB LEDs) can indicate a hazard or improper wiring. In one embodiment, the LEDs continue to function even if one of the breakers has tripped, such as by supplying a battery power reserve as described with reference to FIG. 20, or by drawing inductive power from adjacent circuits in the load panel to power the user interface 2614 and MCU 2610. While an antenna for drawing inductive power from the AC field in the load box is not shown, the generous body dimensions of the breaker/plug device are sufficient to mount an efficient DC generator in the walls of the body. The LED display bank may show status of the appliance or tool 16, for example a ground fault in a tool is detected by device 260, and may show status of the device 2600 if improperly wired during installation.

By adding networking capacity via datalink 2634, the device can be monitored locally or remotely. By adding a clock, battery and memory, chronological records of events can be stored locally and are available to a technician during servicing. By using solid state breaker elements, the devices can include automated testing during down time or at programmed intervals. By adding a DSP, a smart breaker/plug device may learn to recognize fault conditions from the AC waveform at sensing coil 2605.

Networking can be to a cloud host 2000, a server in the building, or can be to a local smart device. Generally, any local service capability is backed up by a cloud administrative server and reports are generated or are accessible to users via a remote interface such as the user's smartphone, home network, or desktop computer, permitting “smart home” integration.

### Example III: GFCI Device with Solid State Components

FIGS. 22A and 22B are views of a modular circuit breaker/plug receptacle combination 2700 with solid state components. The combination device includes logic circuitry and a comm circuit for reporting device status to a network. Data from the device is communicated wiredly or wirelessly to a server or local smart device, for example. The circuit breaker device is generally able to operate independently from a server or local smart device, and includes a user interface. An onboard battery backup for operation of the device electronics is contemplated so that it can resume safe operation when power is restored after a temporary power failure. Details of the grid power connections are not shown because the design is dependent on the configuration of the manufacturer's load panel and the country of use but include at least one hot feed, a neutral, and a ground connection.

Indicator LED 2701 may be an RGB LED, and may by illuminated “red” or “green” depending on the status of the circuit. Switch 2702 permits the circuit to be manually tripped (LED goes to blue) and turned back on (LED goes to green or red, depending on circuit breaker status). Switch 2703 permits manual testing of circuit breaker function, for example a simulated ground fault that will cause the GFCI breaker to trip. In some embodiments, switch 2703 will also permit simulation of a short circuit in the load, an arc fault, or a thermal overload, for example. If a breaker trips, switch 2702 allows the user to reset the device manually so that the plug-receptacle goes live again and indicator 2701 illuminates as a green light if the circuit and any plug-in appliance is clear of any fault condition or test event that tripped the breaker.

The device includes a GFCI-protected plug receptacle 2711a, shown here with a NEMA 5-15R plug receptacle, but may also be provided with an aviation-style threaded receptable as has been described for other embodiments such as FIG. 7A. Operatively associated with the plug receptacle is a solid state breaker and associated circuitry for performing a circuit interrupt in the event that a short, thermal overload, and ground fault is detected. Arc fault detection is optionally included and may include arc fault circuit breaker (AFCI) or low-energy arc and ground fault interruptors (CAFCI/GFCI) combination breaker units.

In embodiments, the breaker assembly also may include solid state circuit components for monitoring installation and operation, such as a green LED when the circuit is correctly installed and tested to be operating correctly, a blue LED when the circuit is manually tripped but is operating correctly, and a red LED to display a fault, such as a ground fault, arc fault, short, or tripped circuit.

The circuit may include one or more analog or digital sensors. Sensor data outputs may include data indicative of temperature, short, arc, ground leakage, open neutral, current, voltage, inductance and impedance, for example. When networked, a server or local smart device can be programmed to detect patterns in the voltage and current data indicative or predictive of the performance condition of the circuit breakers. Sensor data is linked locally to breaker operation by a watchdog circuit with a processor and an instruction set that operates the breaker. The MCU can be linked to a single solid state breaker and will react to any of a plurality of fault conditions detected by the one or more sensors by tripping the breaker and generating an alarm notification. Switch state of user interface switches 2702,2703 is considered to be sensor data, and user commands entered on the user interface are processed according to instructions that are generally stored in local memory.

The breaker/plug device may include a phasor waveform analyzer circuit. The analyzer may be built with a low-jitter clock, an analog-to-digital sampling circuit, and a digital signal processor with memory for storing fault signal patterns, or example, or may include a numerical coprocessor to the MCU and an instruction set stored in EEPROM. Alternatively, the device may transmit snippets of the waveform to a cloud host for analysis and reporting. If an anomalous waveform is detected, the device or cloud host will compare that pattern to a library of fault signals and cause an interrupt in the breaker if likely fault condition is present, or is about to occur. The cloud host may be a learning machine, and will store patterns and outcomes to identify and diagnose incipient fault conditions.

The device may be monitored or controlled by a local operator, for example from a smartphone, or by a network, for example from a cloud server as part of a smart home network. The device may be recognized and monitored by a smart home network or business smart building server. The control center may include a voice interface, for example. The device may also include a piezo-type speaker to provide an audible warning of overload or fault, or other remote alarm notification. The solid state monitoring circuits may be operable even when a load is not connected across plug 2711a.

The solid-state circuit breaker (SSCB) concept works by replacing the conventional electromechanical breaker(s) with power electronics and software or firmware that can trip power to a load with no moving parts. Insulated gate-commutated transistor (IGCT) semiconductor technology is used in one instance. Gate turn-off thyristor (GTO), varistor-linked Zener diode, thermistor, non-linear resistors as surge suppressors, and FET technologies have also been used in combination with separable contacts in older technologies. In one SSCB, a solid state circuit breaker for current interruption is combined with a snubber and metal oxide varistor with a sensor or sensors for flagging one or more fault conditions and a gate driver for opening and closing the circuit breaker gate. Embedded power management software in the device may include predictive algorithms and network reporting capability that are not accessible in conventional circuit breaker technologies.

Digital circuit breakers may include smart algorithms to predict faults before they happen, based on small variances in the AC sine wave. The circuits respond to variations having microsecond timescales and respond in nanoseconds, much more quickly than the millisecond respond expected from traditional GFCI circuit breakers, for example. In one embodiment, each load panel is assigned an IP address on a network, and is controlled or monitored remotely from a central server or from a smart device via a wired or wireless link and using processing power within the panel itself, no external connection to an internet or other external server is needed for basic operation. The primary gain in function with networking is the capacity to store data, to recognize patterns over time, and to make notifications if a trend in the data suggests an imminent fault.

Solid state breakers have another advantage in that they can be tested and reset according to instructions executed by a microcontroller and may not require manual intervention and to be periodically tested. Controllable solid state breaker technology that has been UL approved for commercial use was invented by Atom Power (Huntersville, N.C.) and is the subject of U.S. Pat. No. 10,804,692 to Kennedy, and U.S. Pat. Nos. 8,503,138, 8,891,209 for example. These breakers have not yet fully replaced the solenoid-type trip breakers seen in U.S. Pat. No. 4,115,829, but are significantly improved over the solid state circuit interruptors disclosed in U.S. Pat. No. 4,631,621, for example. Newer improvements are described in US Pat. Publ. No US2021/0066013, 2021/0126447 and 2021/0143630. A single solid state breaker can be adapted as a universal circuit interrupt when paired with digital circuitry for detection or prevention of overload, thermal overload, and ground fault conditions in need of a power interrupt. These improvements supplement the manual user interface provided for breaker devices 2700.

### Example IV: GFCI Device with Radio Network Connection

FIG. 23 is a schematic 2800 with system for radio networking of a circuit breaker/plug receptacle combination 2801 with sensors coupled to a processor (MCU, 2802) configured to interrupt power to plug receptacle 2811a when a fault condition exists or is imminent.

Data may be collected by a sensor package 2803, that may include one or more temperature sensors, pressure sensors, current sensors, voltage sensors, impedance sensors, Hall effect sensors, photocells, accelerometers, GPS sensors that are radio operated, any type of network-assisted AGPS or triangulation of signals for generation of location data such as for tracking of breaker/plug inventory and construction job locations, and one or more of any other type of sensor, without limitation. A ground fault current detector 2804 is also included as a sensor input. Sensors 2807 and 2808 may be current overload and thermal overload sensors, for example. Data from any of the sensor package indicative of a fault condition is processed by MCU 2802 and may result in a command to solid state circuit breaker 2806 that interrupts AC power 3000 to the plug-receptacle. In addition, the plug receptacle is independently grounded 13 through the load panel.

Switches 2816 (TEST) and 2818 (RESET ON/OFF) of user interface 2814 are also considered to be sensors for purposes of explanation, and generate control signals to MCU 2802 in response to user commands entered on the user interface. Generally, a device identifier and an operating system may be included with the circuit breaker, and is accessible via a datalink. This permits new levels of consolidation of demand management efficiency, mixed energy source switchovers, load balancing, and specialized functions such as powering motor startup that can trip conventional breakers.

In some embodiments, a radio unit 2810 is included. The radio unit is operatively coupled to the processor 2802 for broadcasting state of operation and for receiving control commands. Radio units can include Bluetooth, Cellular, WiFi, ultrawideband (UWB), Zigbee, and other radio standards known in the art.

The radio, processor and sensor package may be powered by a backup battery 2812 under control of a power management unit (PMU, 2814). The power management unit will recharge the battery while connected to line power and includes features for extended operation under battery power in the event of loss of line voltage 3000. For example, the microcontroller 2802 can include a low power state in which only the clock is being powered and a wake monitor is set so that the device can wake up according to a clock signal, or some other digital input that awakens one or more processing functions of the device. In some instances, such as when there is a BT radio modem in the device, the modem controller of radio 2810 may be selectively powered to function as networked or ad hoc peer-to-peer “wake radios” or “always listening radios” as a specialized low power operating state that enables the device to be operated from battery power for hours, weeks and even months. A cellular modem may be operated in power savings mode or extended discontinuous receive and transmit to conserve power. A small rechargeable NiCad battery, or a 9V battery such as commonly used in smoke detectors, for example, may suffice for extended use during power interruptions. This ensures that a power surge does not occur when AC power is restored and can also be useful when various renewable power generation technologies such as wind or solar DC or AC are used to supplement or replace grid AC power and require periodic switchovers that may result in fluctuations that would trip conventional circuit breakers. Note that with the breaker body widths extending over multiple slots, larger rechargeable battery units and power management circuitry may be included.

In one embodiment, the radio 2810 is used as a datalink, and may be a Bluetooth (BT) radio. The radio may communicate wirelessly with a smartphone 2830, a vehicle 606, a site hub, or other compatible radio device. The smartphone may collect data from device memory, or operate the device, such as for testing purposes in which the integrity of the overload interrupt, thermal interrupt, arc fault interrupt, or ground fault interrupt is being simulated with millisecond or microsecond response times. The devices include reset features that can be electromechanical, analog or digital, such as lever arms operated by a servo, stepper motor, or winch, or a solid state circuit interrupt 2806 monitored by a digital watchdog, and set or reset with microsecond response time. Logic circuitry supplied in the device may execute self-testing of the GFCI function on a programmable schedule.

The capacity to fully automate testing of the circuit breaker and sensor package is useful in meeting more stringent requirements for periodic testing. Newer UL 943 GFCI standards, for example, may necessitate that GFCI devices test themselves periodically. Although the initial draft standard does not require the device trip its breaker (as would require a manual reset) the device may be required to simulate a ground fault leak and generate a command to trip a breaker in response, even if the solenoid is not actually tripped. Where a solid state breaker is provided, a full test and reset can be performed remotely using a networked breaker device.

Self-testing on an automated schedule (as opposed to manual testing) of GFCI competency has been achieved using microelectronics. Descriptions of IC circuits with clocked automatic self-testing capability are found in a number of references, including U.S. Ser. No. 10/020,649 to Du, U.S. Pat. No. 8,547,126 to Ostrovsky, U.S. Pat. No. 8,085,516 to Armstrong, and U.S. Pat. No. 7,149,065 to Baldwin, for example. Mandatory automatic self-testing has been proposed in newer code to replace the low-compliance calendar-based user testing of earlier codes. The self-testing includes simulated fault and also checks reliability of circuit components. Any failure can result in an automated “lock-out” of the circuit, or a report can be made to a supervisory user so that corrective action can be taken.

In some instances, the radio may communicate with a computing machine that oversees operation of a breaker box and communicates on a channel for receiving data from device 2801 and sending commands to the device. The computing machine may be a local machine such as a smart device, or may be accessed as a cloud resource 2000 which stores performance data, detects trends, and issues commands and notifications based on performance data. Use of a radio link to achieve this level of integration with a network is an advantage over wired connections that require more complex installation and are not readily upgraded. Most radio devices have the capacity to download new software or software patches so that the microcontroller can perform upgrades as needed under control of a system administrator or technician.

Any radio device will include at least one antenna 2820, as will be mounted on or under the faceplate of the device. Surprisingly, BT radio operates smoothly within a closed breaker box in spite of the AC electromagnetic interference and the shielding added by the front cover. Other radio systems that operate in one of the ISM bands or cellular bands may also be incorporated by providing a compatible antenna.

The circuit breaker radio output may also include location data. In one embodiment, GPS is provided as an integrated circuit or built into the radio chip. In other instances, network assisted location services such as AGPS or PoLTE can be enabled. The utility of location services is realized in circuit breakers intended for temporary use at construction sites or for special projects where the location of the device may be needed to retrieve it when the job is finished. A query may be sent to the device that causes the device to execute a location fix and report its position to an operator, or the device may be caused to transmit a signal that enables a network to triangulate its position with a high degree of accuracy.

### Example V: User Interface on Smartphone

FIG. 24 illustrates a smartphone 4001 with installed software 4000 for displaying and operating a breaker/plug control and monitoring interface. This exemplary application is configured for use of the breaker/plug as an EV charging platform. The center panel 4002 includes a graphical display of the progress of recharging a battery, with a projection of the remaining uncharged battery capacity. Immediately above that 4004, is an indication of the charging rate, given in units of kilometers/hour, a rough indication of how far each hour of charging allows the user to drive. The more power available for charging, the more miles an hour of charging will result in. Window 4006 may display the vehicle name; window 4008 may provide notes about the charging history. Window 4010 may include helpful information such as recommended serving of the vehicle, troubleshooting guidance, or even an oscilloscopic view of the AC feed or a listing of component performance in the OBCM, described earlier. Notes that explain the effect of charging speed on battery life may be provided along with a touch control option to increase the charging speed or reduce the time needed for full charge. Window 4012 may include warnings, such as the negative effect of over-depletion of the battery without recharging and may offer to set up a reminder system. The display may also offer links to network help from cloud server 2000, such as finding the nearest charging station or service facility, and can include a garage-door opener feature, for example.

### Example V: System Integration of EV Charger

A smart breaker/plug device 5003, as installed in a load panel 101, may charge vehicle 606 under control of a cloud host 2000 or an end user 1000 with smartphone 4001. The end user may monitor the charging process on display 4001 as described in FIG. 24. Generally, this system is build around a 240 VAC breaker because this provides a reasonable fast charge and is commonly available in the United States.

In FIG. 25, a single cord unit 5001 is supplied to connect the breaker/plug device and the vehicle. Microelectronics used to control the process are no longer in the cord or an “in-line connector box” or wall charging station, but are instead in the breaker/plug device and work in coordination with processing power of the vehicle and in some instances using cloud resources.

As described above, the 240 VAC power supply may not include a neutral line to the load. In some instances, the vehicle is electrically connected to live AC with a floating neutral in which HOT1 and HOT2 provide 240 VAC. In some instances the neutral is used as part of a GFCI protection subcircuit in the breaker. Optionally, however, four-wire cord to the load may be used, and the fourth wire, or any pilot wire in a specialized cord 5000 may be used to carry data. The neutral/ground wires may receive serial data from any UART or ethernet communications chip. However, because of the superior resistance of Bluetooth radio transmissions to AC interference, and the need to communicate with smartphone 4001, radio is potentially more effective and faster that a serial port.

Cord 5000 includes a first plug end 5002 configured to be inserted into the plug receptacle of breaker/plug device 5003 and a second plug end 5004 configured to be inserted into the plug receptacle 5006 of the vehicle 606. Plug end 5002 is configured to matedly connect with the breaker circuits for receiving power, and is protected from circuit faults by the breaker circuits as described in earlier schematics and drawings here. Circuit protections may include overload breaker, short breaker, thermal interrupt, surge suppressor, arc fault interrupt, and ground fault interrupt, for example. Circuit interruptions offsite and feed undervoltage may also be reported.

The cord need not include microelectronic circuitry, except perhaps for an LED or LEDs at the plug ends to illuminate the plug receptacle and assure the user of safe operation. The cord may be stowed in the vehicle or hung on a hook in a garage when not in use, for example. The cord may be 20 ft in length, 25 ft in length, or longer, as required to span the distance from the load center 101 to the vehicle. Power drop is minimized by selection of copper as the conductor and use of 10G or greater cross-sectional area of the conductor. Preferred plug ends 5002 include the NEMA 14-50, 6-50, L14-30, and L6-30 plug types suitable for Class 2 chargers.

In some embodiments, the breaker output will not go hot unless the cord 5000 is connected to the vehicle and the circuit is operating properly. If not, the breaker will remain tripped and help instructions will be displayed on the user's screen 4000. This is achieved by data transmissions between the components of the system. Optionally, the neutral wire of the cord 5000 can carry the pilot data, but a more universal data sharing platform is achieved with radio, either Bluetooth, WiFi, UWB, or cellular, for example. The breaker/plug device is programmable for detecting an electrical connection to a BEV, for parsing data or commands transmitted to the device, and for supplying power according to a command received from the BEV.

The system includes software and firmware in each component as necessary to coordinate and operate a charging process with priority to safety for the end user. The system may also include watchdog components as well as cloud monitoring and reporting to prevent unsafe conditions from developing. The cloud host may be capable of learning to recognize proper and improper use conditions from the signals received from the vehicle, the smartphone and/or the breaker/plug and to adapt new responses and notifications, up to and including shutting down and locking out the breaker, if an unsafe condition is likely. The system may update itself with periodic updates from the cloud administrator 2000.

It is contemplated that articles, apparatus, methods, and processes that encompass variations and adaptations developed using information from the embodiments described herein are within the scope of this disclosure. Adaptation and/or modification of the articles, apparatus, methods, and processes described herein may be performed according to these teachings.

Throughout the description, where articles and apparatus are described as having, including, or comprising specific components, or where processes and methods are described as having, including, or comprising specific steps, it is contemplated that, additionally, there are articles and apparatus that consist essentially of, or consist of, the recited components, and that there are processes and methods that consist essentially of, or consist of, the recited processing steps.

It should be understood that the order of steps or order for performing certain actions is immaterial if the embodiment remains operable. Moreover, two or more steps or actions may be conducted simultaneously.

### INCORPORATION BY REFERENCE

All of the U.S. patents, U.S. patent application publications, U.S. patent applications, foreign patents, foreign patent applications and non-patent publications referred to in this specification and related filings are incorporated herein by reference in their entirety for all purposes.

### SCOPE OF THE CLAIMS

The disclosure set forth herein of certain exemplary embodiments, including all text, drawings, annotations, and graphs, is sufficient to enable one of ordinary skill in the art to practice the invention. Various alternatives, modifications and equivalents are possible, as will readily occur to those skilled in the art in practice of the invention. The inventions, examples, and embodiments described herein are not limited to particularly exemplified materials, methods, and/or structures and various changes may be made in the size, shape, type, number and arrangement of parts described herein. All embodiments, alternatives, modifications and equivalents may be combined to provide further embodiments of the present invention without departing from the true spirit and scope of the invention.

Any original claims that are cancelled or withdrawn during prosecution of the case remain a part of the original disclosure for all that they teach.

In general, in the following claims, the terms used in the written description should not be construed to limit the claims to specific embodiments described herein for illustration, but should be construed to include all possible embodiments, both specific and generic, along with the full scope of equivalents to which such claims are entitled. Accordingly, the claims are not limited in haec verba by the disclosure.

1. A system for charging a battery-powered electric vehicle (“BEV”), which comprises:
a) a breaker/plug device (the “device”) mountable in a load panel, the device having a body with superior exposed surface on which is disposed a grounded plug receptacle configured to receive a mating plug and with inferior surface or surfaces having contacts connectable to line power from the load panel;
b) an electric cord pluggable into the plug receptacle of the device at a first plug end (the “mating plug”) and into a plug receptacle of the BEV at a second plug end, said electric cord forming a closed electrical circuit for transmission of power when plugged in thereto;
c) a first microelectronic circuit in the device and a second microelectronic circuit in the vehicle, such that the two microelectronic circuits are in digital communication; and,
d) a circuit interrupt and fault sensor in the body of the breaker/plug device, the circuit interrupt operating to open the electrical circuit at the plug receptacle if an electrical fault is detected.

2. The system of claim 1, wherein the circuit interrupt is open unless the mating plug is operably plugged into the device at the first end and the cord is operably plugged into the BEV at the second end.

3. The system of claim 1, wherein the body of the device is of a modular form factor compatible with one, two, three or four adjacent slots of a hot bus bar in a load panel.

4. The system of claim 1, wherein the device and the cord are operable with single phase 240 VAC power.

5. The system of claim 1, wherein the device operates with 240 VAC and has a ground fault sensor operably connected to the circuit interrupt.

6. The system of claim 1, wherein the device operates with 240 VAC, has a ground fault sensor operably connected to the circuit interrupt, and has a floating neutral connection to the cord.

7. The system of claim 1, wherein the circuit interrupt is open unless a compatible BEV is detectable in radio proximity thereto.

8. The system of claim 1, wherein the device includes in its body a Bluetooth radio or another radio set.

9. The system of claim 1, wherein the device includes circuitry in its body for automatic self-testing of the fault sensor.

10. The system of claim 1, wherein the device includes circuitry in its body for automatic self-testing of the circuit interrupt.

11. The system of claim 1, wherein the device includes in its body a plurality of fault sensors comprising fault sensors for detecting circuit overload fault, ground fault and arc fault.

12. The system of claim 11, wherein the device in its body comprises a single interrupt operable to break the electrical circuit if a circuit overload fault, ground fault or arc fault is detected.

13. The system of claim 1, wherein the device is programmable for detecting a mis-wiring during its installation.

14. The system of claim 1, wherein the device is programmable to detect an electrical connection to a BEV and to supply charging power according to a command received from the BEV.

15. The system of claim 1, wherein the device comprises a phasor waveform analyzer circuit.

16. The system of claim 15, wherein the phasor waveform analyzer circuit comprises a low-jitter clock, an analog-to-digital sampling circuit, and a digital signal processor with memory for storing fault signal patterns.

17. The system of claim 1, further comprising a cloud host configured to perform administrative functions, to monitor device performance, and to generate alerts and notifications according to instructions provided by a system administrator or programmed by an end user.

18. The system of claim 1, further comprising a set of instructions on computer-readable memory, which when installed in and executed by a smartphone, cause the smartphone to display a graphical user interface with touch-sensitive controls, and to communicate data and instructions to and from the breaker/plug device and the BEV.

19. The system of claim 1, wherein the device and the cord are configured as a Class 2 electric vehicle charging system.

20. The system of claim 1, wherein the device is assigned an IP and MAC address and is accessible on the IOT.

21. A method for charging a battery-powered electric vehicle, which comprises the system of claim 1.

22. A breaker/plug device for charging a battery-powered electric vehicle (“BEV”), which comprises:
(a) an insulative body mountable in a load panel, the exterior shell having a superior exposed surface on which is disposed a grounded plug receptacle configured to receive a mating electrical plug and inferior surface or surfaces having hot contacts connectable to line power from the load panel, said contacts including a first hot contact and a second hot contact for receiving a 240 VAC single-phase live power feed, wherein each said hot contact is contactable to a hot bus bar of the load panel;
(b) in the body, a circuit interrupt in series between the plug receptacle and the hot contacts, and a ground fault sensor, wherein the circuit interrupt is configured to interrupt the electrical circuit at the plug receptacle if a ground fault is detected by the ground fault sensor; and,
(c) in the body, control circuitry powered by the load panel, wherein said control circuitry is configured to detect a BEV in need of charging in proximity thereto and to charge the BEV through the plug receptacle according to an instruction received remotely.

23. The device of claim 22, wherein the device is configured with a floating neutral; and, the neutral connector of the plug receptacle is repurposed to receive a pilot wire enabled to carry the instruction from a BEV.

24. The device of claim 22, wherein the circuit interrupt is open unless electrically connected to a BEV in need of electric power.

25. The device of claim 22, wherein the device comprises a radio and the instruction is receivable via a radio link.

26. The device of claim 22, comprising a plurality of fault sensors for detecting circuit overload fault, thermal fault, and ground fault; and, each said fault sensor is operatively linked to trip said circuit interrupt.

27. The device of claim 26, wherein the device comprises circuitry for automatic self-testing of the fault sensor or sensors.

28. The device of claim 22, wherein the device comprises circuitry for automatic self-testing of the circuit interrupt.

29. The device of claim 22, wherein the device includes watchdog circuitry for automatic functional self-testing prior to each use or according to a regular schedule.

30. The device of claim 22, wherein the device comprises a single interrupt operable to break the electrical circuit at the plug receptacle if a circuit overload fault, ground fault or arc fault is detected.

31. The device of claim 22, further comprising a display on said superior surface; and wherein the device is programmable for detecting a mis-wiring during its installation and displaying a diagnostic notification.

32. The device of claim 22, wherein the device comprises a USB connection configured for connecting a troubleshooting device or a USB gooseneck lamp.

33. The device of claim 22, which comprises a radio link configured to connect to a network or a smartphone.
